(19) United States
(12) Patent Application Publication
(10) Pub. No.: US 2026/0096501 A1
(43) Pub. Date: Apr. 9, 2026

(54) SOLAR-POWERED INTEGRATED AGRICULTURAL MONITORING SYSTEM FOR SMART FARMING AND AI-TRAINED YIELD PREDICTION

(71) Applicant: Advent Innovations Limited Company, Columbia, SC (US)

(72) Inventors: Malichi Flemming, Columbia, SC (US); Corey Leydig, Irmo, SC (US); Shawn Beard, Bishop, CA (US); Ritubarna Banerjee, Irmo, SC (US)

(73) Assignee: Advent Innovations Limited Company, Columbia, SC (US)

(21) Appl. No.: 19/297,078

(22) Filed: Aug. 12, 2025

Related U.S. Application Data
(60) Provisional application No. 63/682,006, filed on Aug. 12, 2024.
(60) Provisional application No. 63/710,268, filed on Oct. 22, 2024.

(51) Int. Cl. A01B 79/00; G16Y 10/05; G16Y 20/10; G16Y 40/10

(52) U.S. Cl. CPC A01B 79/005; G16Y 10/05; G16Y 20/10; G16Y 40/10

(57) ABSTRACT

The subject matter disclosed herein is generally directed to solar-powered devices for the collection of soil and environmental data in agricultural areas where continuous monitoring and wireless data transmission is required.

### TECHNICAL FIELD

The subject matter disclosed herein is generally directed to solar-powered devices for the collection of soil and environmental data in agricultural areas where continuous monitoring and wireless data transmission is required.

### BACKGROUND

Typically, farmers rely on the periodic collection of soil samples, previous experience, and intuition to make decisions on how to best treat their farmland to maximize crop yield and crop quality. Lab testing of soil samples can be an expensive, laborious, and time-consuming endeavor. While this process is accurate, the inability to constantly monitor the state of the soil leads to assuming erroneous conclusions about the soil that could result in making poor decisions. After factoring in a rapidly escalating population causing a higher demand for food and more environmental effect on agriculture land, it is critical that a more efficient approach is developed to counteract these problems.

Smart Internet of Things (IoT) devices have been used for a variety of applications in other industries including manufacturing, transportation, healthcare, retail, energy management, IT infrastructure, and autonomous vehicles. The popularity of the IoT devices have even grown significantly in everyday household products such as wearable health monitors, security systems, kitchen appliances, thermostats, and voice assistants. While smart IoT devices have begun to enter the agricultural industry, advancement remains slow and there remains plenty of potential to utilize IoT devices to improve the farming sector. The solar-powered devices and software will be used to constantly collect data significant to the maintenance and production of farmland periodically, transmit the data wirelessly to a database server, visualize the data in a simplistic format on any internet-capable device, and implement decision-based Artificial Intelligence (AI) to guide users to best tend soil optimal crop yield.

Accordingly, it is an object of the present disclosure to provide a complete solar-powered IoT data-collection system for various assets, including agricultural land.

Citation or identification of any document in this application is not an admission that such a document is available as prior art to the present disclosure.

### SUMMARY

The above objectives are accomplished according to the present disclosure by providing in one instance a system for sensing farm conditions. The system may include at least one sensor node configured to gather information about at least one farm; at least one website; and at least one communication protocol service for establishing communication between the at least one sensor node and the at least one website. Further, the at least one sensor node may collect real time data about at least one farm condition. Additionally, the at least one farm condition may be selected from ambient temperature, soil temperature, ambient pressure, ambient humidity, soil electrical conductivity, soil moisture, GPS data, ambient light conditions, at least one wind condition or combinations of the above. Yet still, the system may be configured to provide access to the information gathered by the at least one sensor node via any device that can access the internet. Moreover, the at least one sensor note may be configured to be waterproof. Still further, the at least one website may be an account-based website configured to allow access in real time to the information gathered by the at least one sensor node over a course of time the at least one sensor node is active. Further again, an artificial intelligence software module may be included and configured to provide information on improving field health and crop production. Yet again, the system may provide at least one agro-informatic data. Still further, the at least one agro-informatic data may include a normalized difference vegetation index (NDVI), an enhanced vegetation index (EVI), a disease stress water index (DSWI), a normalized difference water index (NDWI) and/or combinations of the above. Yet still, the system may include at least one capacitive soil moisture sensor circuit.

In another instance, the current disclosure may provide a farm sensor node. The node may include at least one antennae, at least one solar leaf configured to provide power to the farm sensor node, at least one microcontroller configured to control the farm sensor node, at least one real time clock configured for keeping time per a time zone containing at least one farm, at least one multiplexer configured to control a dataflow from and to at least one farm sensor via serial communication, at least one thermocouple temperature sensor, and at least one environmental sensor configured to collect real time data about at least one farm condition. Still further, the at least one farm condition may be selected from ambient temperature, soil temperature, ambient pressure, ambient humidity, soil electrical conductivity, soil moisture, GPS data, at least ambient light condition, or at least one wind condition or combinations of the above. Yet again, the node may include at least one TDS module configured to collect electrical conductivity data. Still again, the at least one sensor note may be configured as waterproof. Additionally, the farm sensor node may be configured to communicate with at least one website configured to allow access in real time to the real time data gathered by the at least one sensor node over a course of time the at least one sensor node is active. Moreover, the farm sensor node may be configured to communicate with an artificial intelligence software module configured to provide information on improving field health and crop production. Additionally, the farm sensor node may be configured to collect at least one agro-informatic data. Further yet again, the at least one agro-informatic data may include a normalized difference vegetation index (NDVI), an enhanced vegetation index (EVI), a disease stress water index (DSWI), a normalized difference water index (NDWI) and/or combinations of the above.

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows an example of an overview for the FieldRich data collection system.

FIG. 2 shows an example of an overview of the LoRaWAN communication.

FIG. 3 shows an example of the Advent Digital Farming concept.

FIG. 4 shows an example illustration of the full data collection system.

FIG. 5 shows designs of DigiNode of the current disclosure.

FIG. 6 shows blow out view of current DigiNode disclosure.

FIG. 7 shows the design of the DigiNode's PCB from the front.

FIG. 8 shows the design of the DigiNode's PCB from the back.

FIG. 9 shows an example of the DigiNode PCB microelectronics.

FIG. 10 shows an example of a communication and location module for the DigiNode.

FIG. 11 shows an example of a TDS sensor.

FIG. 12 shows an example of a environmental sensor.

FIG. 13 shows an example of a thermocouple probe sensor.

FIG. 14 shows an example of parts to construct electrical conductivity probe.

FIG. 15 shows an example of antennas for the DigiNode.

FIG. 16 shows an example rechargeable Lithium Polymer battery for the DigiNode.

FIG. 17 shows an example of solar cells for the DigiNode.

FIG. 18 shows the schematic design of the DigiNode PCB of the current disclosure.

FIG. 19 shows a power system flow chart of the DigiNode of the current disclosure.

FIG. 20 shows a further embodiment of the DigiNode of the current disclosure.

FIG. 21 shows a blowout view of a further embodiment of the current disclosure.

FIG. 22 shows a front view of a further PCB design of the current disclosure.

FIG. 23 shows a back view of a further PCB design of the current disclosure.

FIG. 24 shows an example of PCB microelectronics of a further embodiment of the current disclosure.

FIG. 25 shows an example of an ambient light sensor of a further embodiment of the current disclosure.

FIG. 26 shows an example of a GPS module of a further embodiment of the current disclosure.

FIG. 27 shows an example of a 555 timer of a further embodiment of the current disclosure.

FIG. 28 shows the schematic design of a further embodiment of the DigiNode PCB of the current disclosure.

FIG. 29 shows a power system flow chart of a further embodiment of the DigiNode of the current disclosure.

FIG. 30 shows an image of the main shell of the gateway of the current disclosure.

FIG. 31 shows an example of components located in the main shell of the gateway.

FIG. 32 shows an image of the main shell of the gateway with example components.

FIG. 33 shows an example of a Lithium Iron Phosphate battery for the gateway.

FIG. 34 shows an example of a waterproof fan for the gateway.

FIG. 35 shows an example of additional components located in the main shell of the gateway.

FIG. 36 shows an example of a Raspberry Pi and LoRaWAN stack of the gateway.

FIG. 37 shows an example Bill of Materials of the gateway PCB.

FIG. 38 shows an example schematic of the gateway PCB.

FIG. 39 shows an image of the gateway PCB.

FIG. 40 shows an example of the gateway PCB microelectronics.

FIG. 41 shows an example of antennas for the gateway.

FIG. 42 shows an image of the front shell of the gateway of the current disclosure.

FIG. 43 shows an image of the top shell of the gateway of the current disclosure.

FIG. 44 shows an image of a design of the gateway of the current disclosure.

FIG. 45 shows an example of a solar panel charging kit of the gateway of the current disclosure.

FIG. 46 shows an example setup of the gateway and solar charging kit of the current disclosure.

FIG. 47 shows a power system flow chart of the gateway of the current disclosure.

FIG. 48 shows the home page of the FieldRich website.

FIG. 49 shows the login page of the FieldRich website.

FIG. 50 shows the registration page of the FieldRich website.

FIG. 51 shows the about us page of the FieldRich website.

FIG. 52 shows the features page of the FieldRich website.

FIG. 53 shows the contact us page of the FieldRich website.

FIG. 54 shows the home page of the FieldRich website.

FIG. 55 shows the DigiNode page of the FieldRich website.

FIG. 56 shows the Agro Informatics page (top half) of the FieldRich website.

FIG. 57 shows the Agro Informatics page (bottom half) of the FieldRich website.

FIG. 58 shows the FieldRich page of the FieldRich website.

FIG. 59 shows the mobile app FieldRich home page.

FIG. 60 shows the mobile app FieldRich registration page.

FIG. 61 shows the mobile app FieldRich login home page (top).

FIG. 62 shows the mobile app FieldRich login home page (bottom).

FIG. 63 shows the mobile app FieldRich menu sidebar.

FIG. 64 shows the mobile app FieldRich DigiNode current data.

FIG. 65 shows the mobile app FieldRich DigiNode graphical data viewer.

FIG. 66 shows the mobile app FieldRich DigiNode node locations viewer.

FIG. 67 shows the mobile app FieldRich agro-informatics satellite data.

FIG. 68 shows the mobile app FieldRich agro-informatics graphical display of satellite data.

FIG. 69 shows the mobile app FieldRich hourly and daily weather forecast.

FIG. 70 shows the mobile app FieldRich store page.

FIG. 71 shows the mobile app FieldRich settings page.

FIG. 72 shows the mobile app FieldRich edit user data page.

FIG. 73 shows the mobile app FieldRich edit added user's page.

FIG. 74 shows a flowchart representing power and data flow throughout main DigiNode PCB.

FIG. 75 shows one embodiment of a Main DigiNode PCB Schematic.

FIG. 76 shows a rendering of main DigiNode PBC: a. back and b. front.

FIG. 77 shows a flowchart representing power and data flow throughout Solar Charger and Ambient Sensor PCB.

FIG. 78 shows a Solar Charger and Ambient Sensor PCB Schematic.

FIG. 79 shows a rendering of Solar Charger and Ambient Sensor PCB: a. back and b. front.

FIG. 80 shows a 3D rendering of an assembled DigiNode sensor.

FIG. 81 shows an exploded view of DigiNode Sensor with labeled components.

FIG. 82 shows one embodiment of a Login Page of the current disclosure.

FIG. 83 shows one embodiment of a Home Page of the current disclosure.

FIG. 84 shows one embodiment of a Network Page of the current disclosure.

FIG. 85 shows one embodiment of a Chirpstack Page showing Chirpstack Configurations of the current disclosure.

FIG. 86 shows one embodiment of a Chirpstack Page showing MQTT Configurations of the current disclosure.

FIG. 87 shows one embodiment of a Chirpstack Page showing one embodiment of a Service Status indicator.

FIG. 88 shows one embodiment of a Settings Page of the current disclosure.

FIG. 89 shows one embodiment of a DigiNode Main Window of the current DISCLOSURE

FIG. 90 shows one embodiment of a Created Filed of the current disclosure.

FIG. 91 shows one embodiment of Field Creation Screen.

FIG. 92 shows one embodiment of a Diginode Plot Viewer.

FIG. 93 shows one embodiment of a Diginode Plot Viewer with the Ambient Temperature Plot Selected.

FIG. 94 shows one embodiment of a Surface Plot Visualization Window of the current disclosure.

FIG. 95 shows one embodiment of a Surface Plot Visualization Showing Week-By-Week status.

FIG. 96 shows one embodiment of a Surface Plot Visualization Showing Month-By-Month status.

FIG. 97 shows one embodiment of a Surface Plot Visualization Showing Comparison Between two Sensor Values.

FIG. 98 shows one embodiment of a Diginode Tracker View of the current DISCLOSURE

FIG. 99 shows one embodiment of an Alerts Window Shown of the current DISCLOSURE

FIG. 100 shows one embodiment of an Alerts Window Showing the Thresholds

### Editor.

FIG. 101 shows one embodiment of an Agro-informatics New Satellite Windows Viewer.

FIG. 102 shows one embodiment of a System Architecture Flow Diagram of the current disclosure.

FIG. 103 shows one embodiment of a Data Pipeline Diagram of the current disclosure.

The figures herein are for illustrative purposes only and are not necessarily drawn to scale.

### DETAILED DESCRIPTION OF THE EXAMPLE EMBODIMENTS

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by reference as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are several values disclosed herein, and that each value is also herein disclosed as “about” that value in addition to the value itself. For example, if the value “10” is disclosed, then “about 10” is also disclosed. Ranges can be expressed herein as from “about” one value, and/or to “about” another value. Similarly, when values are expressed as approximations, by use of the antecedent “about,” it will be understood that the value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

As used herein, the terms “weight percent,” “wt %,” and “wt. %,” which can be used interchangeably, indicate the percent by weight of a given component based on the total weight of a composition of which it is a component, unless otherwise specified. That is, unless otherwise specified, all wt % values are based on the total weight of the composition. It should be understood that the sum of wt % values for all components in a disclosed composition or formulation are equal to 100. Alternatively, if the wt % value is based on the total weight of a subset of components in a composition, it should be understood that the sum of wt % values the specified components in the disclosed composition or formulation are equal to 100.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### KITS

Any of the hardware and software described herein can be presented as a combination kit. As used herein, the terms “combination kit” or “kit of parts” refers to the components, parts, pieces, modules, and any additional components that are used to package, sell, market, deliver, and/or provide the combination of elements or a single element, such as the devices described herein. Such additional components include, but are not limited to, packaging, blister packages, and the like. When one or more of the components, parts, pieces, modules, and any additional components described herein or a combination thereof (e.g., a device provided alone or a device provided with constituent parts/pieces for assembly) contained in the kit are provided simultaneously, the combination kit can contain the device alone or the device provided with other accoutrements for installation, modification, and/or upkeep. When the components, parts, pieces, modules, and any additional components described herein or a combination thereof and/or kit components are not provided simultaneously, the combination kit can contain the device and constituent parts in separate combinations. The separate kit components can be contained in a single package or in separate packages within the kit.

In some embodiments, the combination kit also includes instructions printed on or otherwise contained in a tangible medium of expression. The instructions can provide information regarding the device(s), installation/upkeep/maintenance information, information regarding use, etc. In some embodiments, the instructions can provide directions and protocols for assembling and using a device of the present disclosure or providing maintenance to same. In some embodiments, the instructions can provide one or more embodiments of the methods for making devices of the current disclosure as any of the methods described in greater detail elsewhere herein

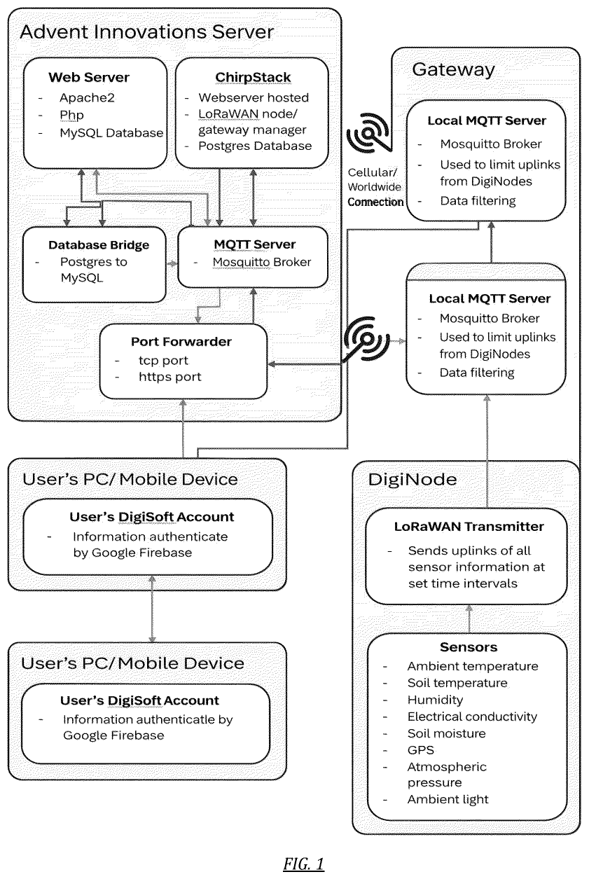

Details shown in FIG. 1 describe an example of the overall communication between the end user and the DigiNodes. The user interacts with the FieldRich website through an account-based system that offers a unique and personal feel for the user's farm and location while also relaying information about their current farm's weather and farm Agro-informatics. The website also allows direct access to the DigiNode sensor information and location across their field. The website acts as a portal to which the user can view the data stored in their database and all incoming data from the DigiNode as the sensor information is wirelessly streamed through the internet and onto the Advent Innovations server computer.

This server houses the website and DigiNode's main communication protocol service known as ChirpStack. ChirpStack is responsible for the communication between the gateways that are located out in the field and the website's database. It is ChirpStack that uses a basic internet of things (IoT) structure where communication through a MQTT server to and from the gateway is achieved. This MQTT communication is how ChirpStack relays information to and from the gateways out in the field by receiving stat updates from the gateway every 5 minutes to ensure a stable connection. It also listens for the data that each node relays to the gateway through this same communication protocol. This MQTT server is able to communicate through the internet by having its traffic funnel through a TCP tunnel that is forward onto the world wide web and is accessible by the gateways.

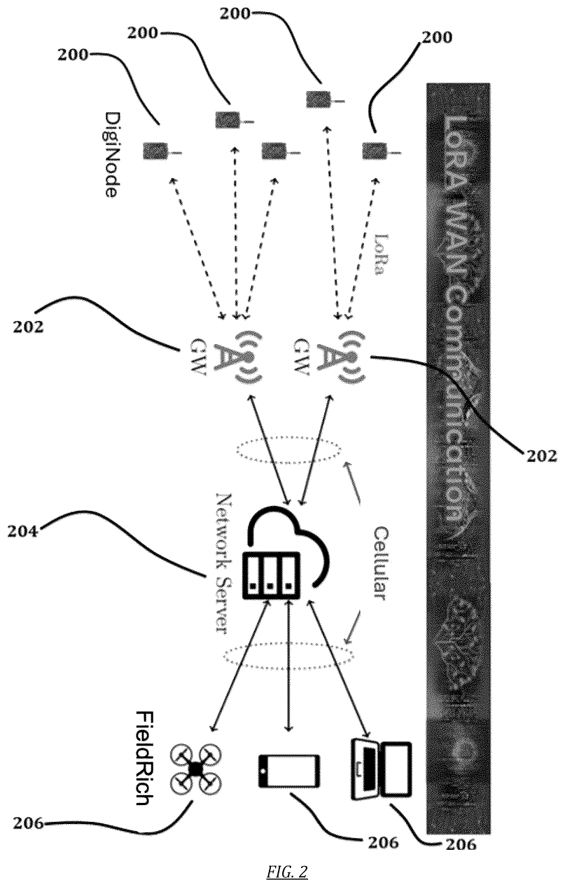

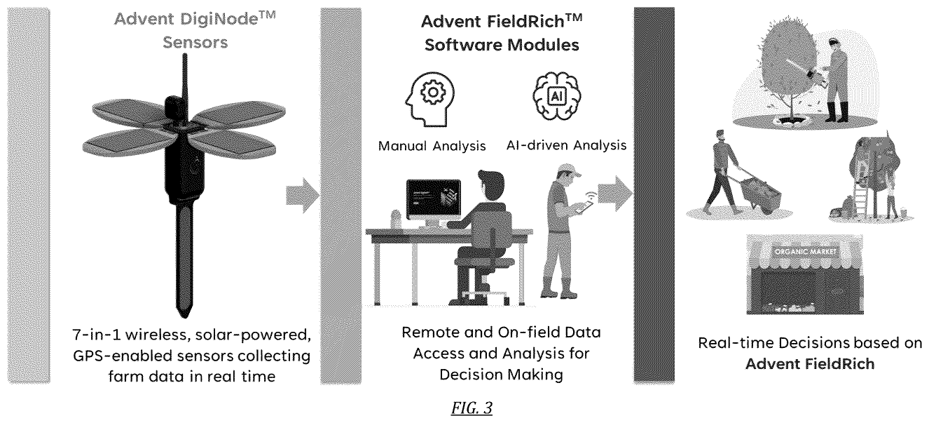

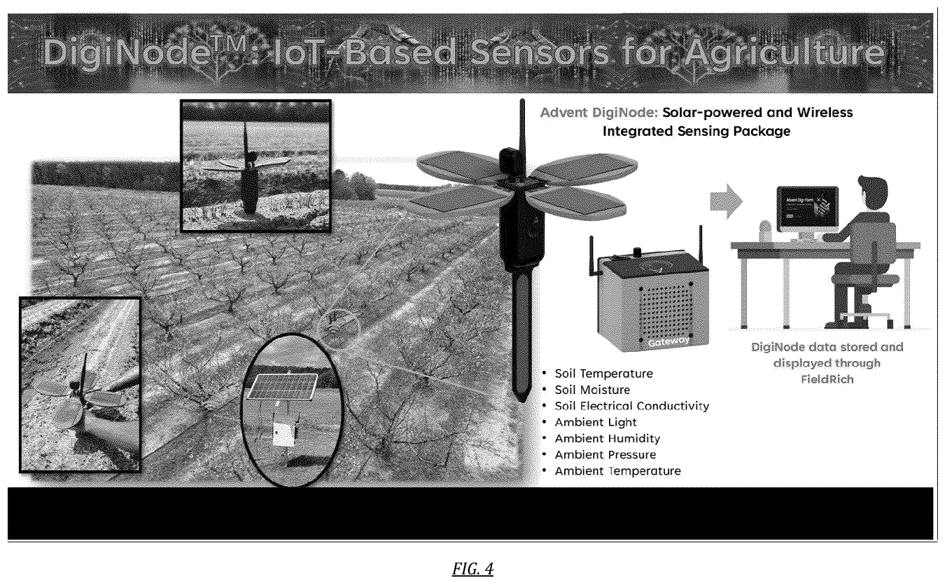

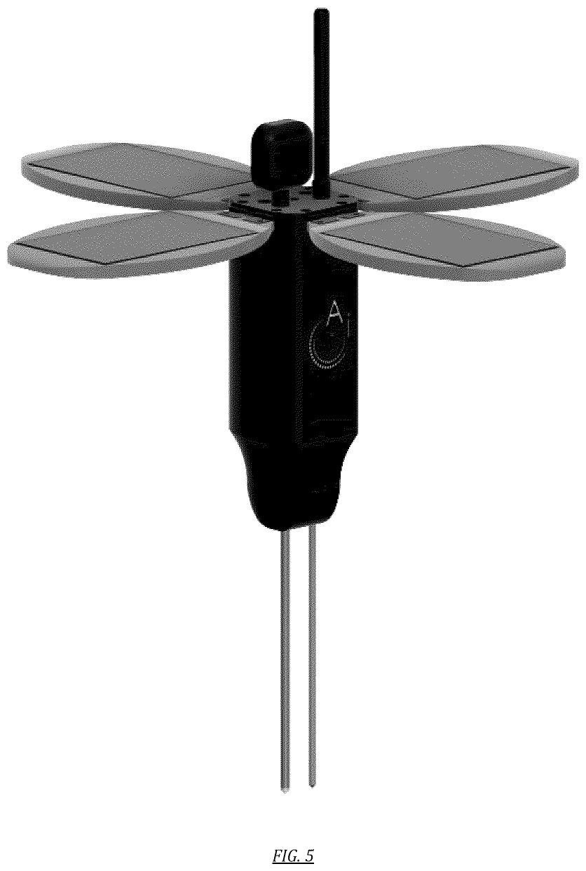

The gateways house a LoRaWAN receiver/transmitter that receives communication to and from the DigiNodes represented in FIG. 2-4. The DigiNodes, pictured in FIG. 5, are devices that are placed in the field and collect real time data through a series of on-board sensors that collect information about various aspects of the field including the ambient temperature, soil temperature, ambient pressure, ambient humidity, soil electrical conductivity, soil moisture, GPS data and ambient light readings. These readings are sent to the gateway where they are prepared for transmission through the internet and onto the Advent server where the data is stored in a database and is accessible by the user through their account on the FieldRich website.

Further embodiments are illustrated in the following Examples which are given for illustrative purposes only and are not intended to limit the scope of the disclosure.

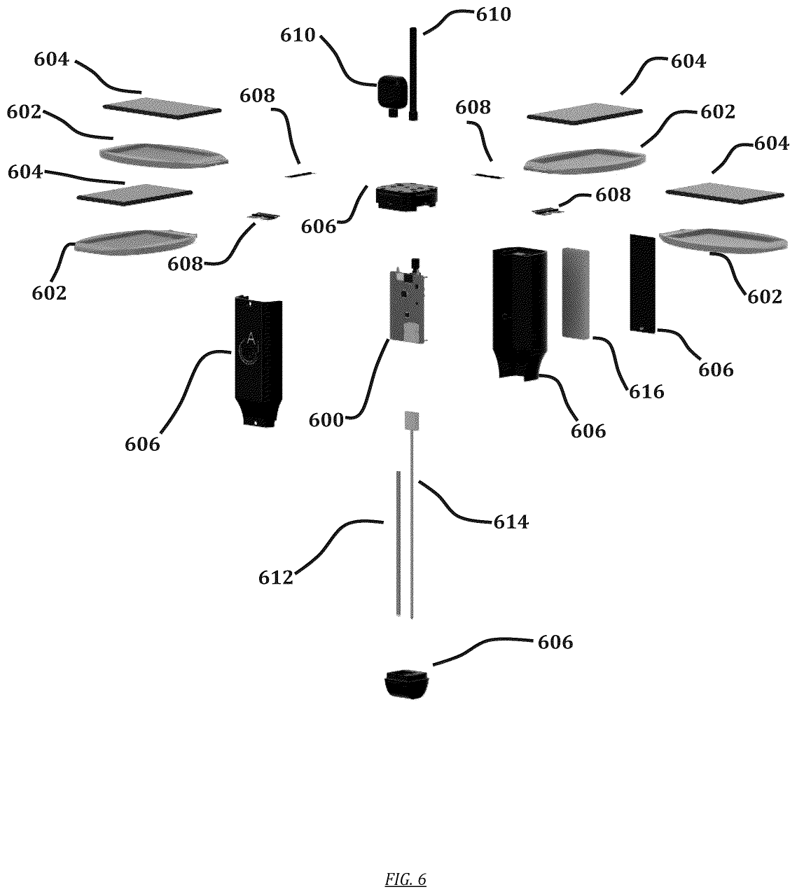

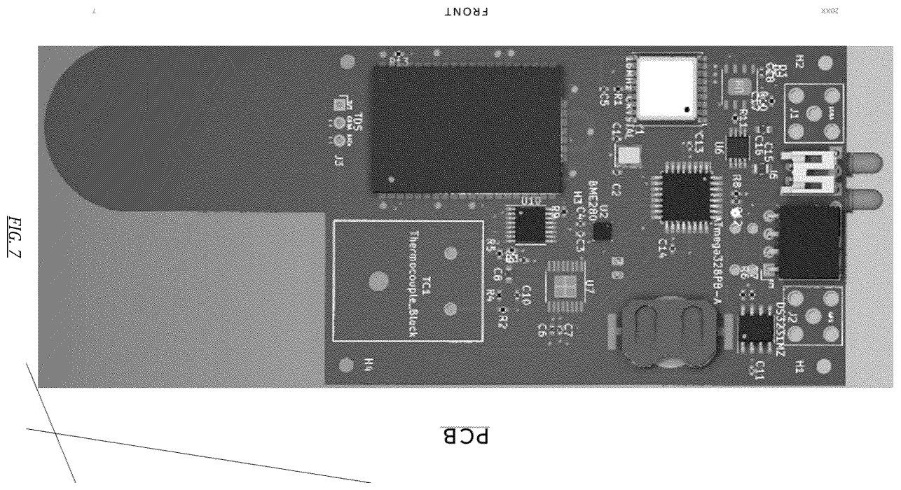

An example implementation of the DigiNode, shown in a blown-out view in FIG. 6, consists of custom PCB 600 which acts as the brain of the device. The DigiNode incorporates multiple solar leaves which combine a plastic leaf-shaped housing 602 and a solar cell 604 for solar power capability. The PCB is contained within a waterproof and weatherproof grade plastic enclosure 606 to protect sensitive electronics from harsh environments. The solar leaves are connected to the enclosure via self-opening spring hinges 608. Opening in the top of the enclosure allows for mounting of antennas 610, and openings in the bottom of the enclosures allows for mounting of an electrical conductivity 612 probe and temperature probe 614.

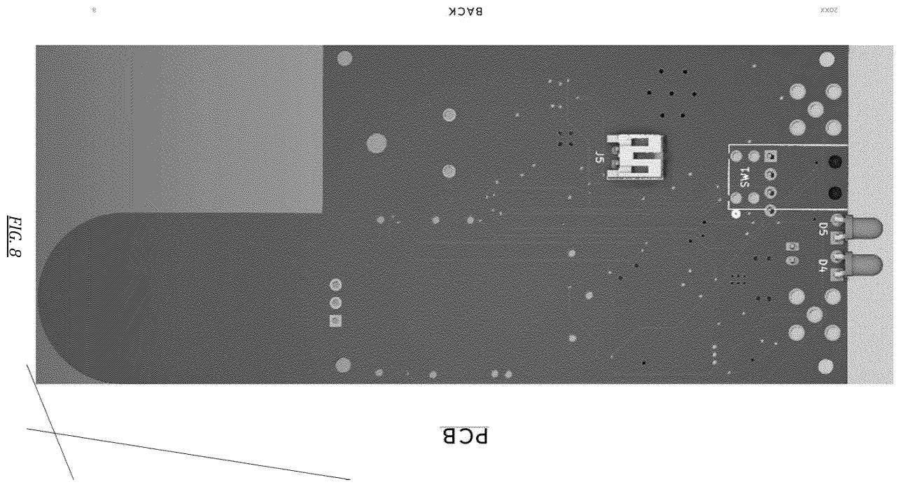

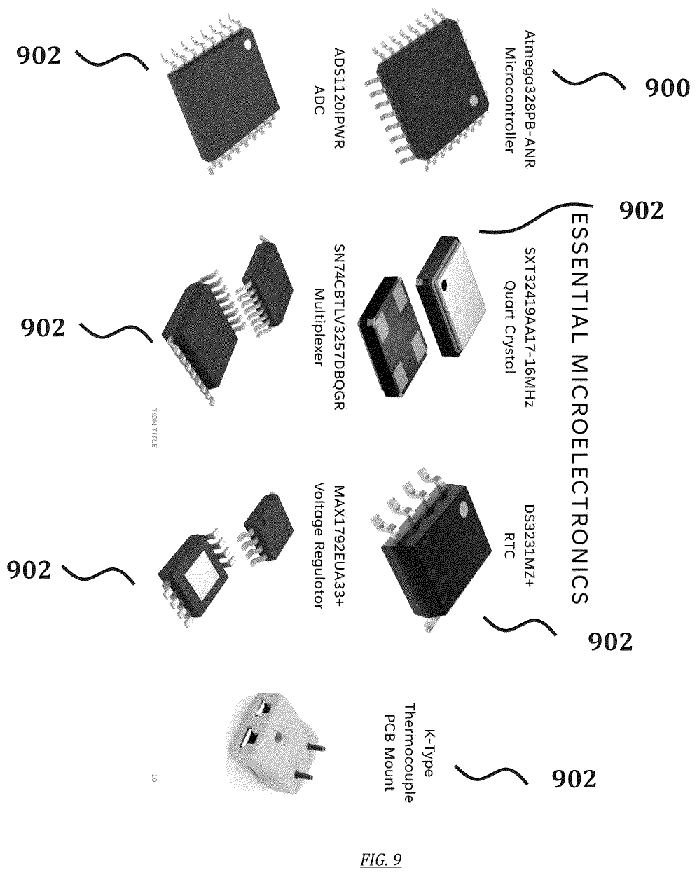

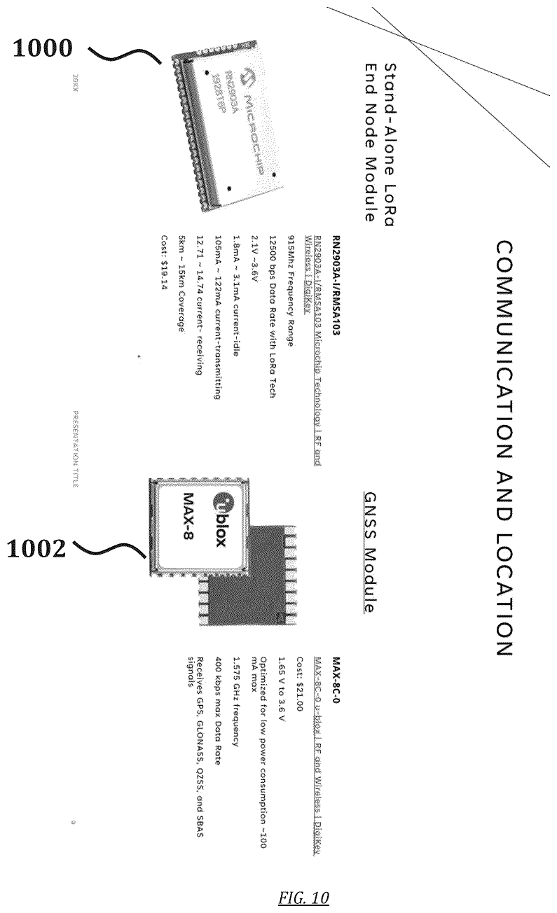

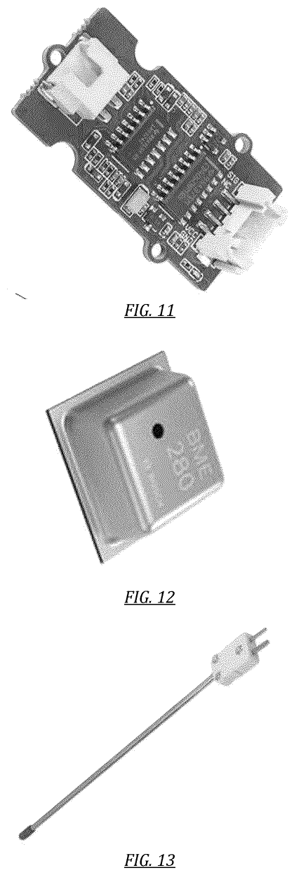

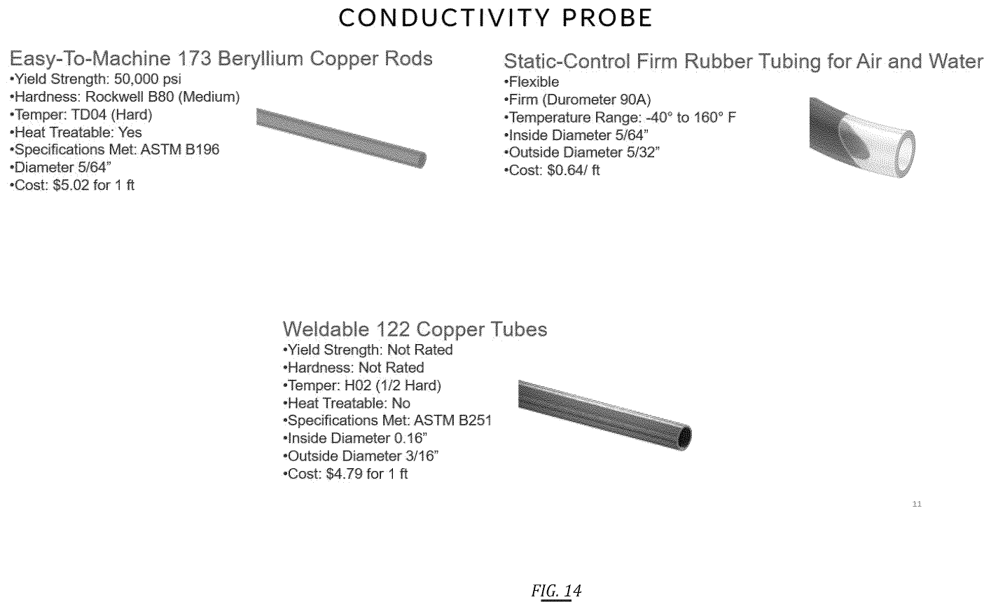

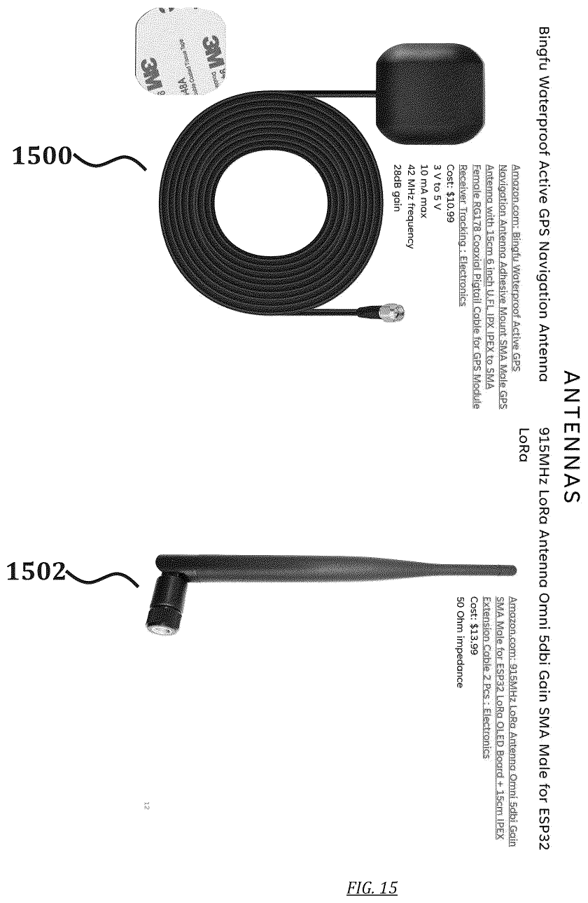

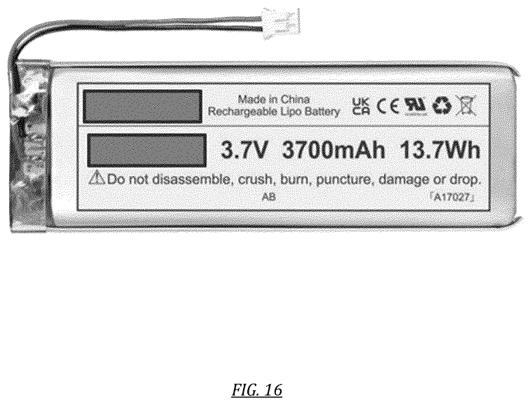

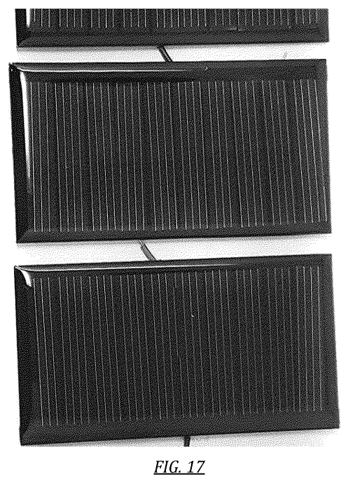

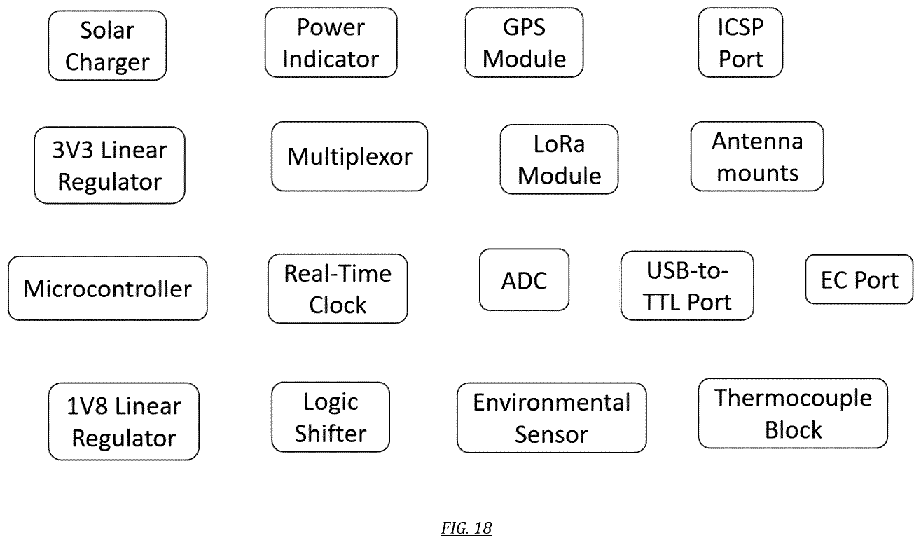

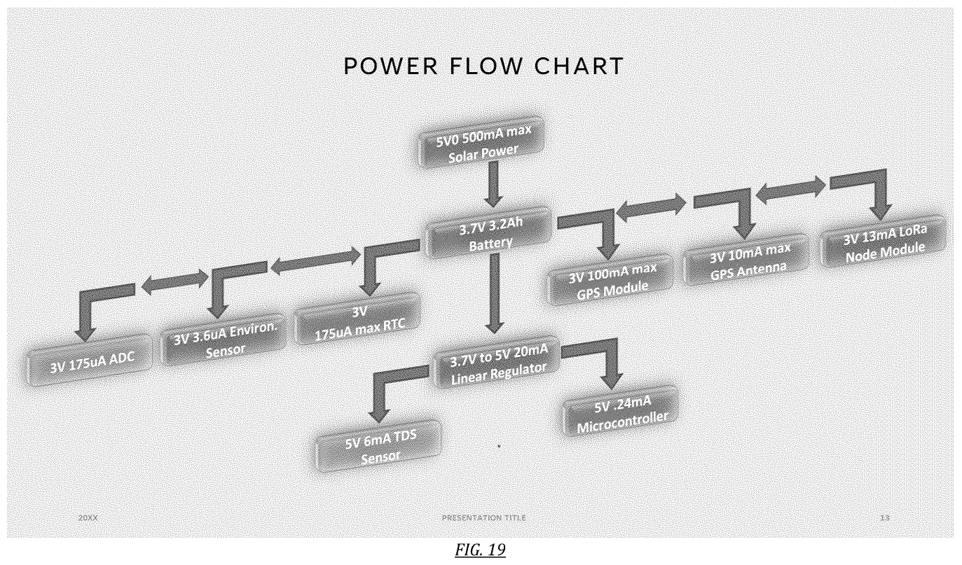

FIG. 7-8 provides rendered 3D views of the front and back of an example DigiNode PCB, and FIG. 9 shows possible essential electronics necessary for the DigiNode. The DigiNode, is controlled by a low-power microcontroller, such as an Atmega328pb 900, in conjunction with an external clock, such as an 8 Mhz crystal oscillator 902. A real-time clock 904 is used for keeping track of time. An external high-resolution ADC, such as ADS1120 906, is utilized to digitalize analog data. A multiplexer 908 is used to control dataflow to and from the DigiNode via serial communication. A voltage regulator 910 that converts input voltage from a battery to a constant 3.3 volts is used to supply power to all active components. To connect a thermocouple temperature sensor, a thermocouple PCB mount 912 is utilized. Detailed in FIG. 10 is a high precision GPS module, such as a MAX-M8C 1000, and a RN2903A 915-Mhz LoRaWAN module 1002 which allows for location data collection and wireless communication, respectively. To collect electrical conductivity, a TDS module is used, shown in FIG. 11. Ambient, temperature, ambient humidity, and barometric pressure are collected by the microcontroller using an environmental sensor, such as BME280, shown in FIG. 12. FIG. 13 details a thermocouple probe which enables soil temperature reading. FIG. 14 shows the parts needed to build a custom electrical conductivity probe that feeds into the TDS module. Detailed in FIG. 15 are the antennas for the GPS module 1500 and LoRaWAN module 1502, respectively. FIG. 16 shows a 3.7 volt 3700 mAh battery and FIG. 17 shows a 5 volt 250 mAh solar cell which both supply power to the DigiNode. The DigiNode PCB schematic and power flow chart are shown in FIG. 18 and FIG. 19, respectively.

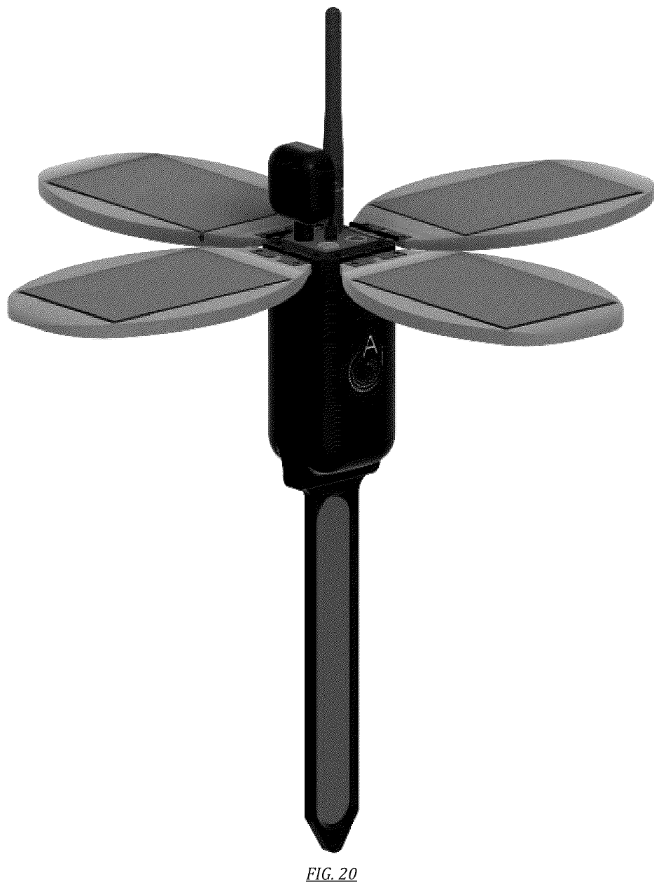

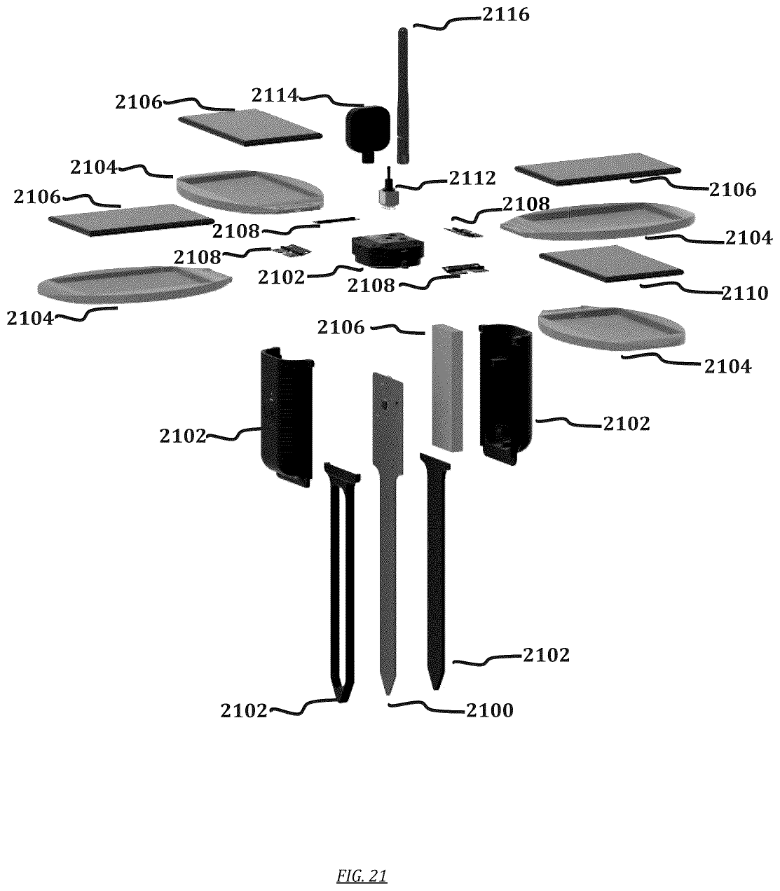

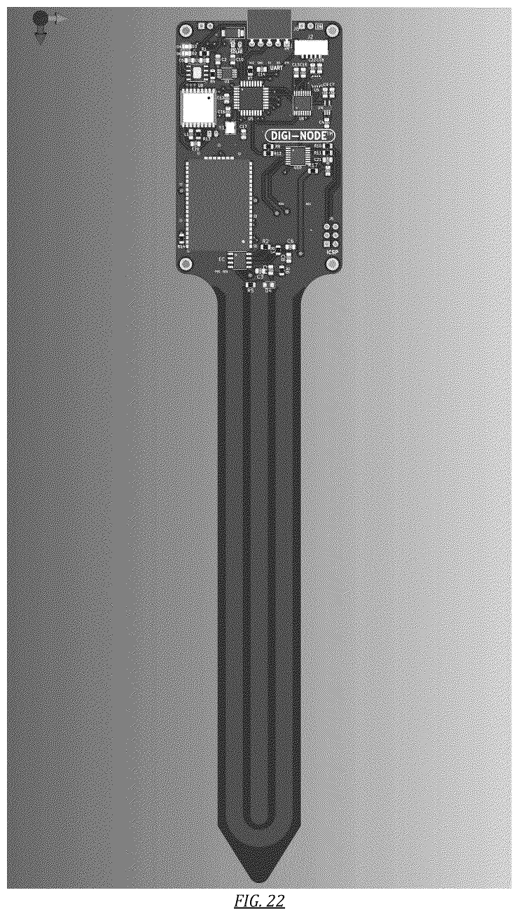

Another example implementation of the DigiNode is detailed in FIG. 20 with a blown-out view shown in FIG. 21. This DigiNode incorporates a custom PCB that also replaces the temperature and electrical conductivity probes 2100 and is contained within a waterproof and weatherproof grade plastic enclosure 2102 to protect sensitive electronics from harsh environments. Multiple solar leaves combine a plastic leaf-shaped housing 2104 and a solar cell 2106 for solar power capability. The solar leaves are connected to the enclosure via self-opening spring hinges 2108. The battery 2110 is contained inside the enclosure behind the PCB. Opening in the top of the enclosure allows for mounting of the toggle switch 2112 GPS antenna 2114 and the LoRaWAN antenna 2116.

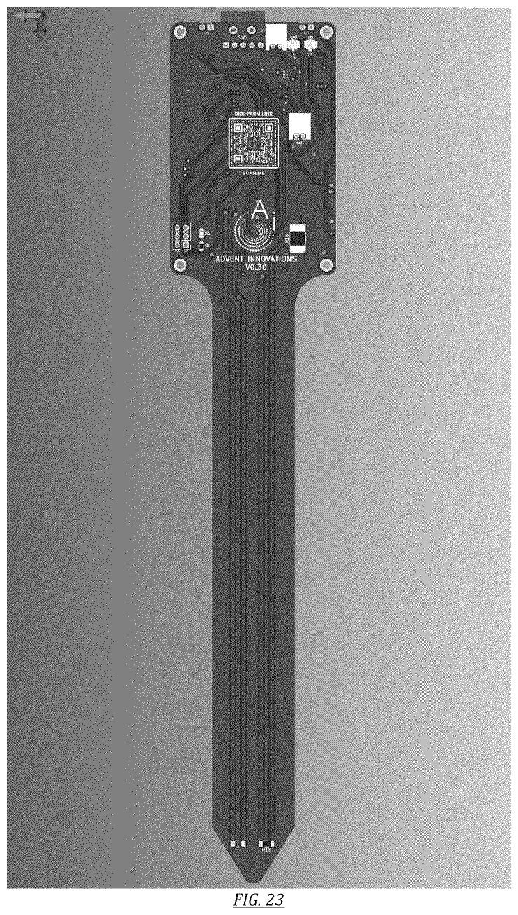

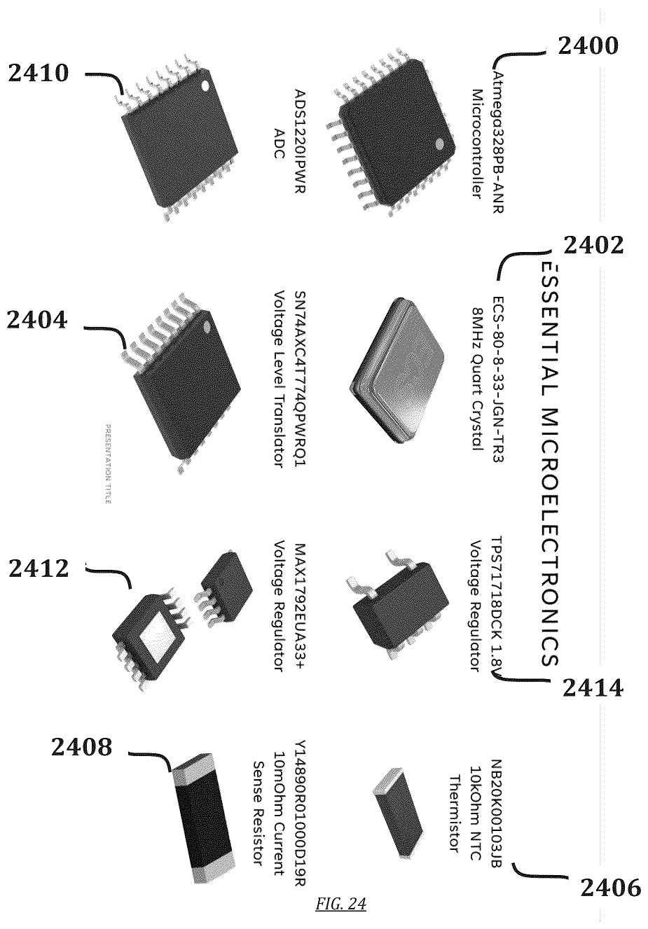

FIG. 22-23 provides rendered 3D views of the front and back of the example DigiNode PCB, and FIG. 24 shows possible essential electronics necessary for the DigiNode. The DigiNode, respectively. is controlled by a low-power microcontroller, such as an Atmega328pb 2400, in conjunction with an external clock, such as an 8 Mhz crystal oscillator 2402. A voltage level translator, such as the 4-bit SN74AXC4T774-Q1 2404, is connected if the logic level of the environmental sensor does not match the logic level of the microcontroller. A temperature sensor, such as a 10-kOhm NTC thermistor 2406, is used to collect the soil temperature. A low value ultra-high-precision resistor 2408 is used to collect the electrical conductivity data by being put in series with the pads of a surface mount resistor purposely left unpopulated. When soil makes contact with the open pads, a voltage divider circuit is created because the soil acts as a resistor. The output voltage of the circuit is directly proportional to the electrical conductivity of the soil. This is true because the output voltage of a voltage divider circuit changes when one resistor or both resistors in the circuit changes. Since the value of ultra-high-precision resistor is extremely stable regardless of temperature fluctuation, the resistance the soil creates can be calculated using the voltage divider equation, Eq. 1

$${v}_{out} = {v}_{in} ( \frac{{R}_{2}}{{R}_{1} + {R}_{2}} ) \cdot {V}_{in} , {R}_{2} , {R}_{1} ,$$

and vₒᵤₜ represents the input voltage of the voltage divider circuit, the resistance of the ultra-high-precision resistor, the resistance of the soil, and the output voltage of the voltage divider circuit, respectively. This equation can be rewritten to find the soil's resistance as shown in Eq. 2,

$${R}_{1} = {R}_{2} ( \frac{{v}_{in} - {v}_{out}}{{v}_{out}} ) .$$

To find the electrical conductivity of the soil, the resistivity of the soil must first be derived from its resistance using Eq. 3,

$$R = ρ ( \frac{L}{A} ) \cdot R , ρ ,$$

L, and A represents the resistance of the soil, the resistivity of the soil, the distance between the centers of the two contacts of the unpopulated surface mount resistor pad, and the cross-sectional area of the contacts, respectively. This equation can be rewritten to find the soil resistivity. Sec Eq. 4,

$$ρ = R ( \frac{A}{L} ) .$$

The electrical conductivity of the soil can be found by calculating the inverse of the soil's resistivity as shown in Eq. 5,

$$σ = \frac{1}{ρ} .$$

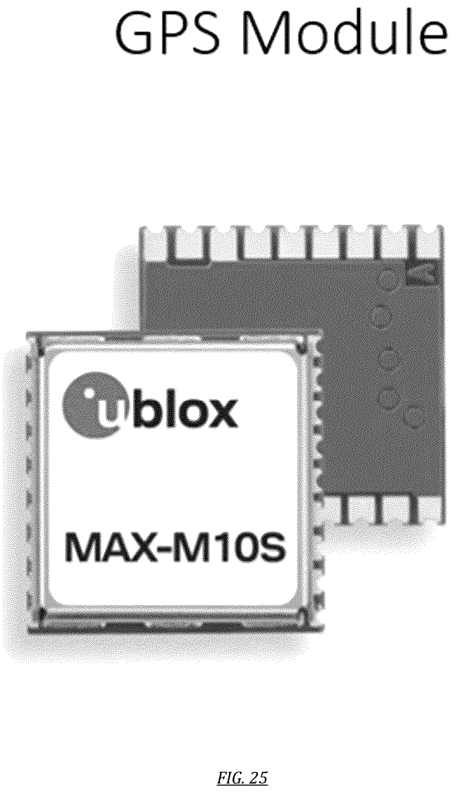

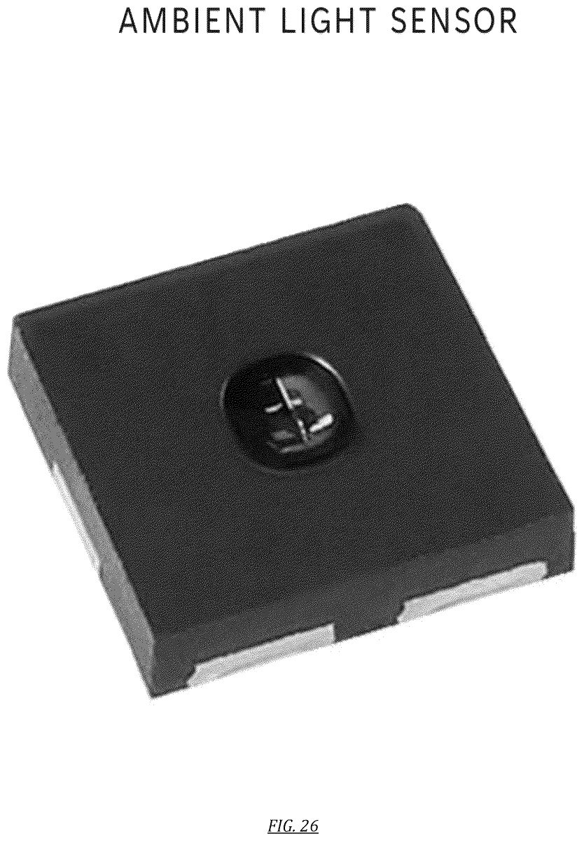

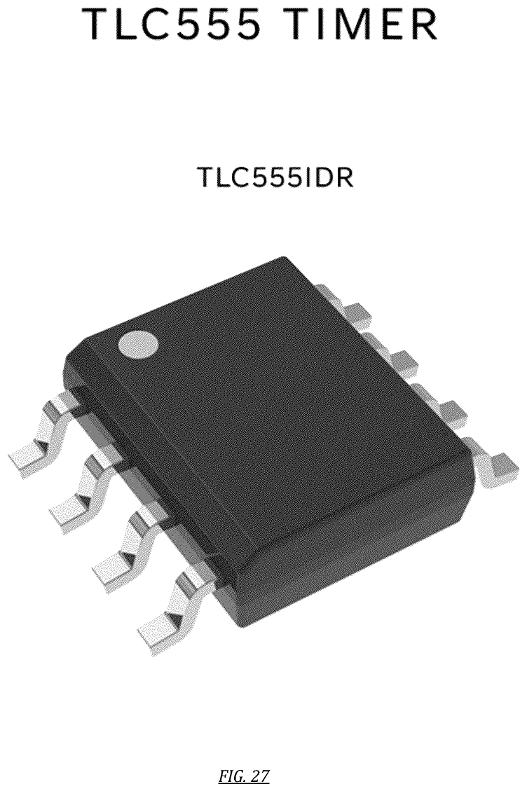

The copper contacts are coated with a corrosion resistance solder paste and a conformal coating is also applied to the PCB. If needed, the electrical conductivity sensor can be calibrated and verified using a 3-point calibration solution. An external high-resolution ADC, such as an ADS1220 2410, is utilized to digitalize analog data. Location data is collected using a high precision GPS module, such as a MAX-MIOS FIG. 25. FIG. 26 shows an ambient light sensor used for detecting variation in sunlight. oil Moisture data is collected by incorporating a 555 timer, FIG. 27 combined with a RC filter, a peak detector circuit and coplanar traces to create a capacitive soil moisture sensor. Since water has a higher relative permittivity than dry soil and the dielectric constant of a medium is proportional to its capacitance, moisture levels can be calculated by measuring the medium's resonance frequency which is a function of the material's dielectric constant Once all data is collected, the data is transmitted using a long range rf transceiver, such as a RN2903A 915-Mhz LoRaWAN module 900.

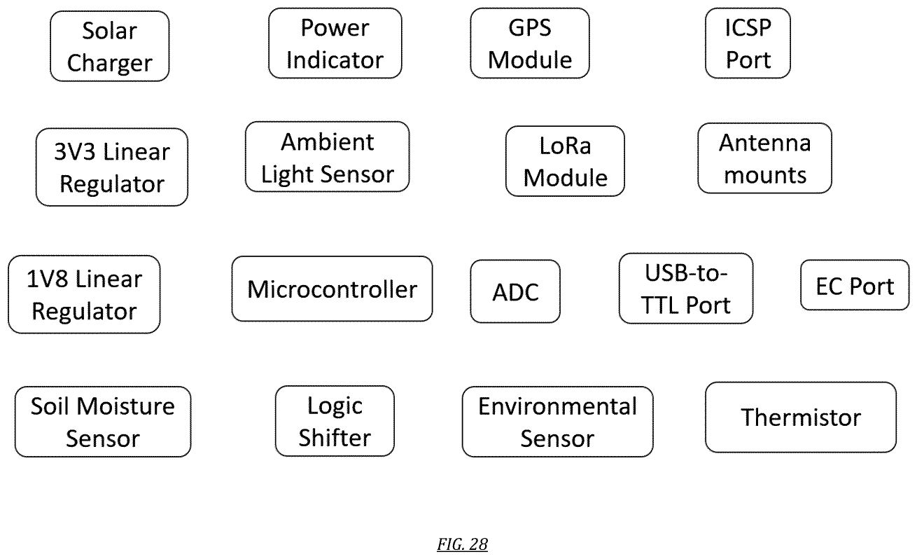

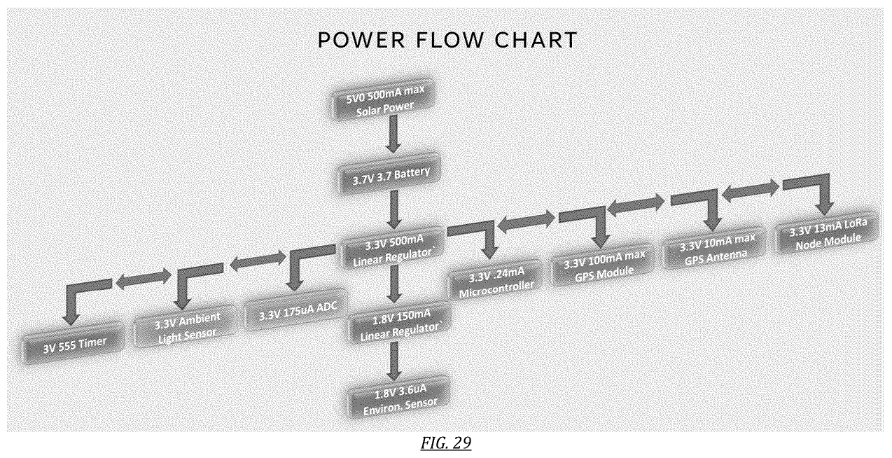

Power is supplied to all components via a 3.7-volt rechargeable LiPo battery, shown in FIG. 16. The LiPo battery is recharged with a solar battery charger, such as a CN3083, and four 5-volt solar cells wired in parallel. Indicator lights, such as surface mount and/or panel mount LEDs, are used to visually represent stages of operation of the device and data transfer activity. A switch, such as a panel mount waterproof toggle switch, is used to turn the device on and off. All components are housed on or connected to a multi-layer PCB. The lower portion of the PCB has a pointed shape to easily penetrate the ground. The PCB has header and/or connectors for communication protocols such as ICSP and UART to program the device. The DigiNode PCB schematic and power flow chart are shown in FIG. 28 and FIG. 29, respectively.

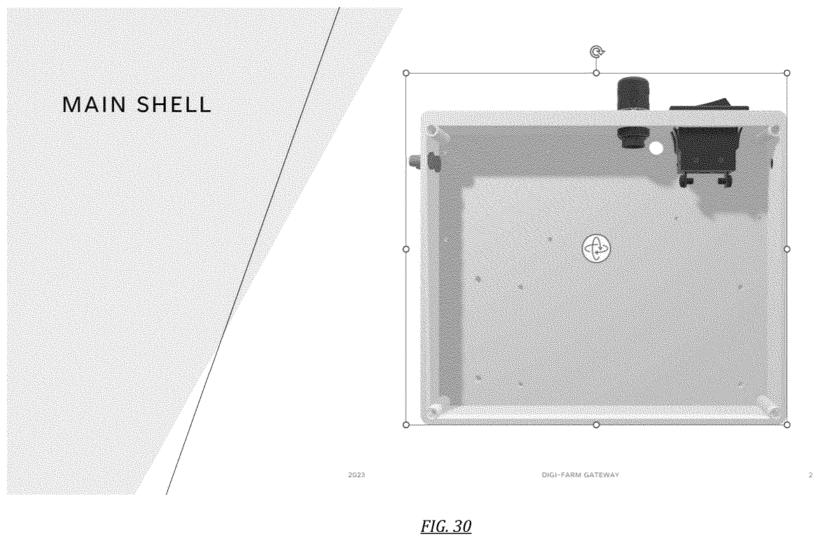

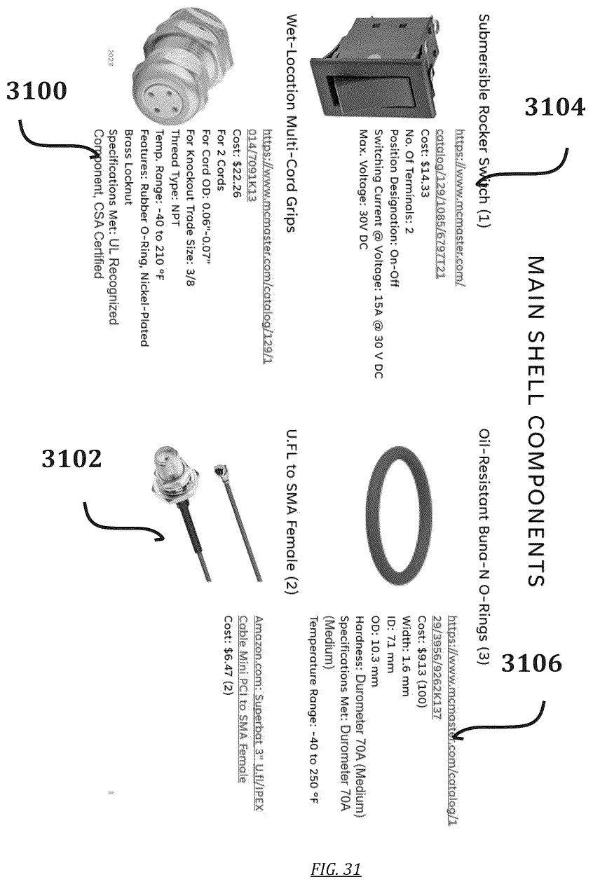

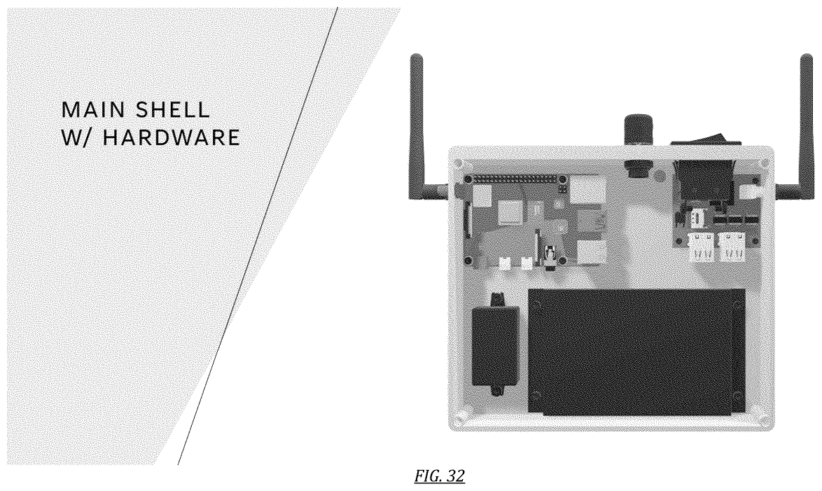

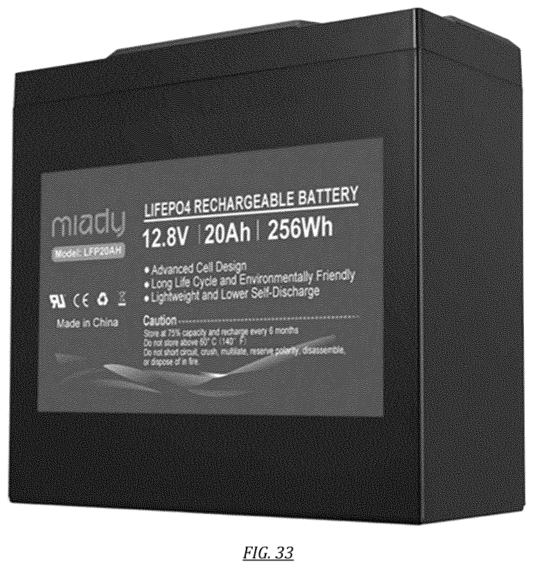

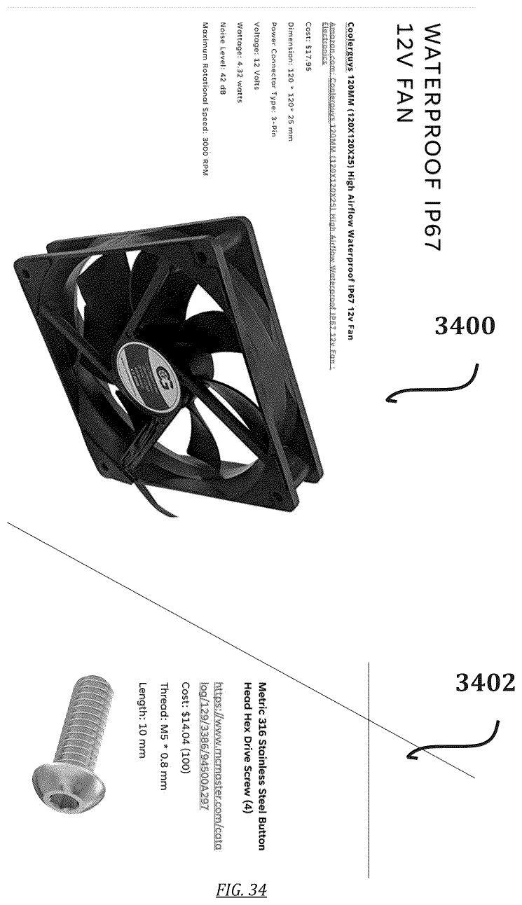

The DigiNode Gateway is the bridge that connects the DigiNode to the internet enabling real-time monitoring of the data collected from the DigiNode anywhere in the world using any device that can access the internet. FIG. 30 shows the main shell of an example implementation of the Gateway and FIG. 31 shows the hardware contained on the Gateway. The hardware consists of a cable grip 3100 which allows waterproof access for the solar panel cable, female U. FL to SMA cables 3102 for connecting antennas to circuit boards, a submersible rocker switch 3104 to turn the Gateway on and off, and O-rings 3106 to waterproof access holes for the U. FL to SMA cables. A 3D model image of the Gateway's main shell with internal electrics is displayed in FIG. 32. FIG. 33 details a 12-volt 20 Ah LiFePo4 battery that powers the Gateway system. A waterproof 12-volt fan 3400 to regulate the Gateway's temperature is shown in FIG. 34 with screws 3402.

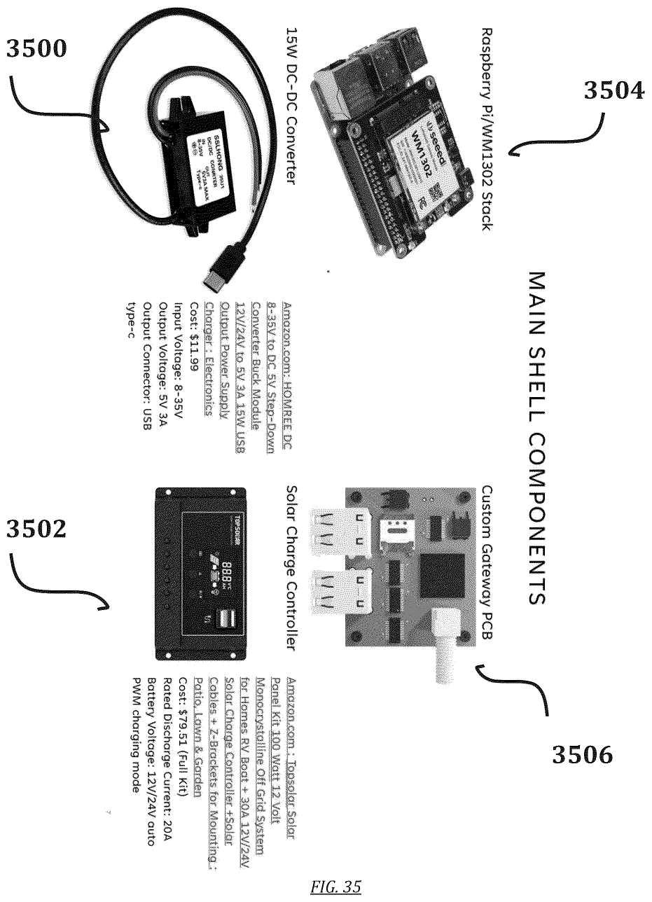

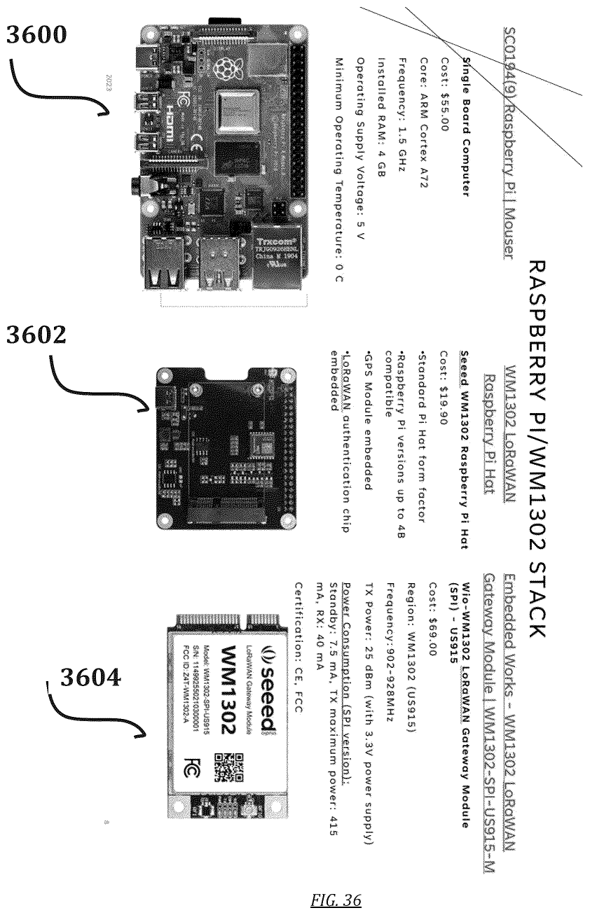

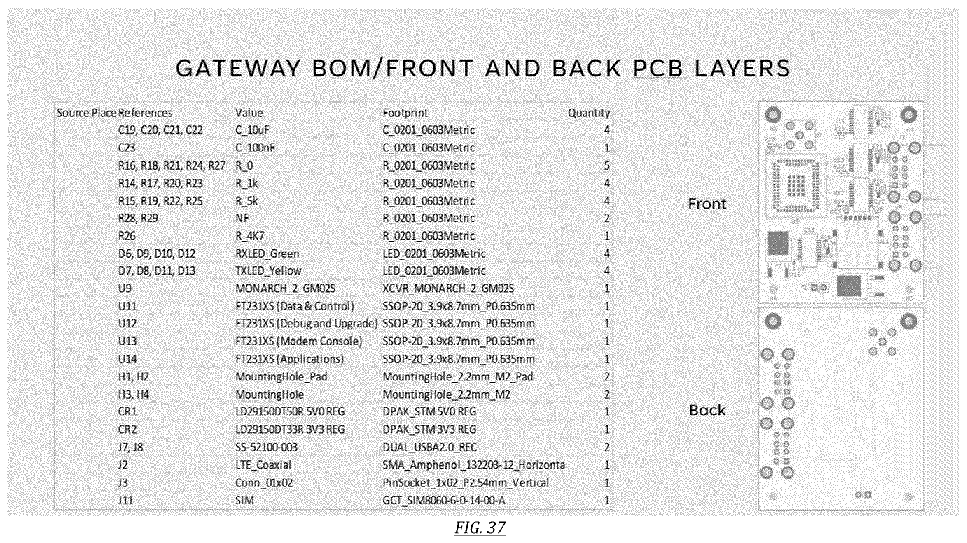

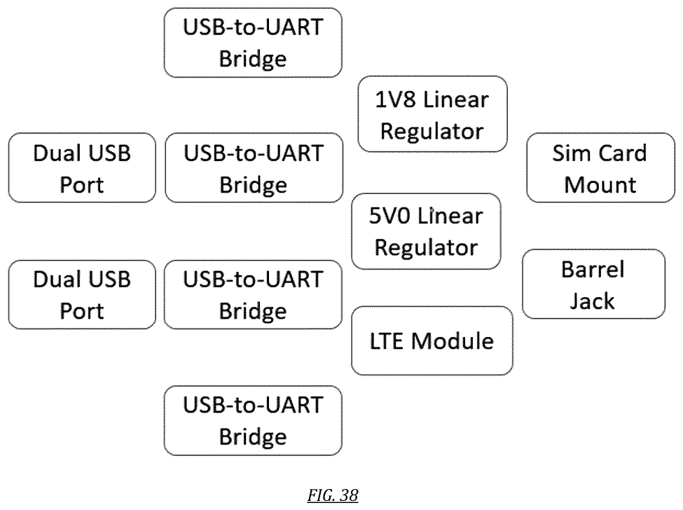

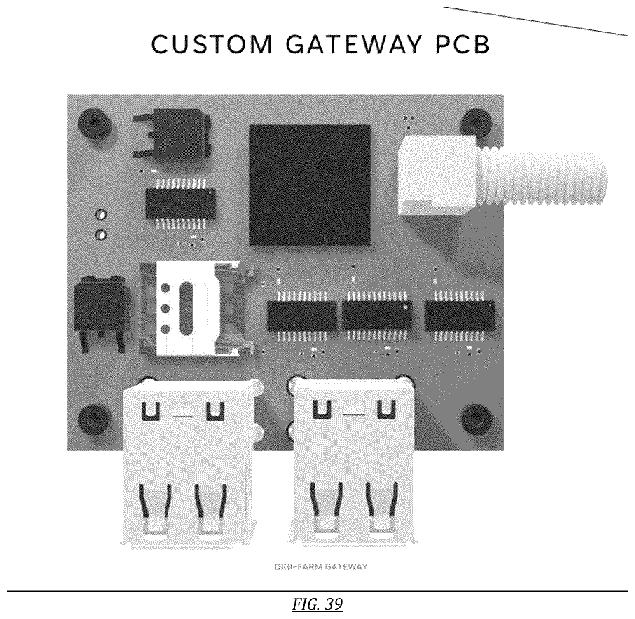

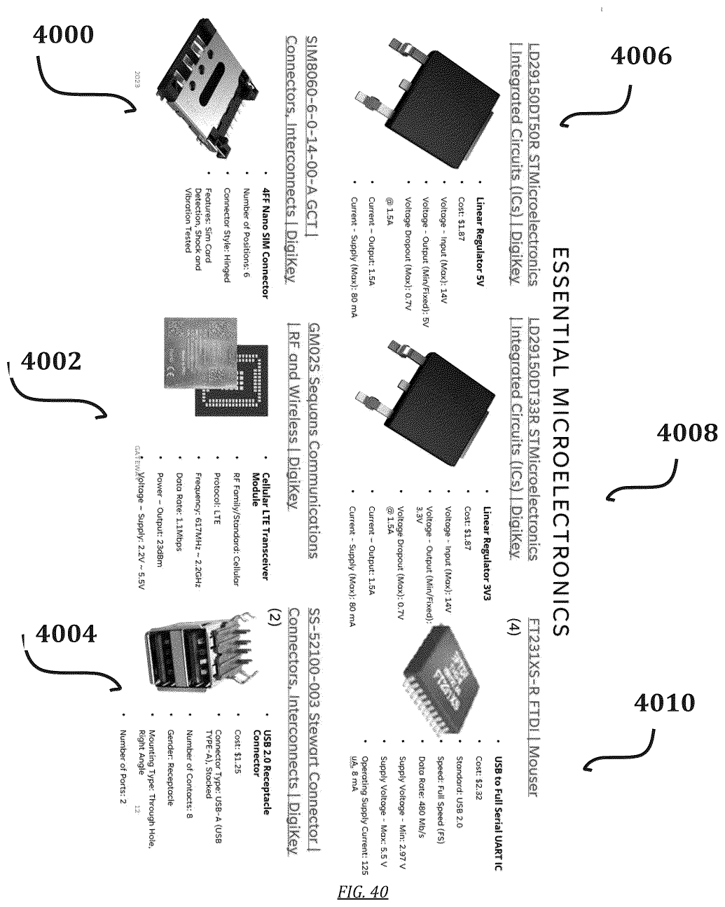

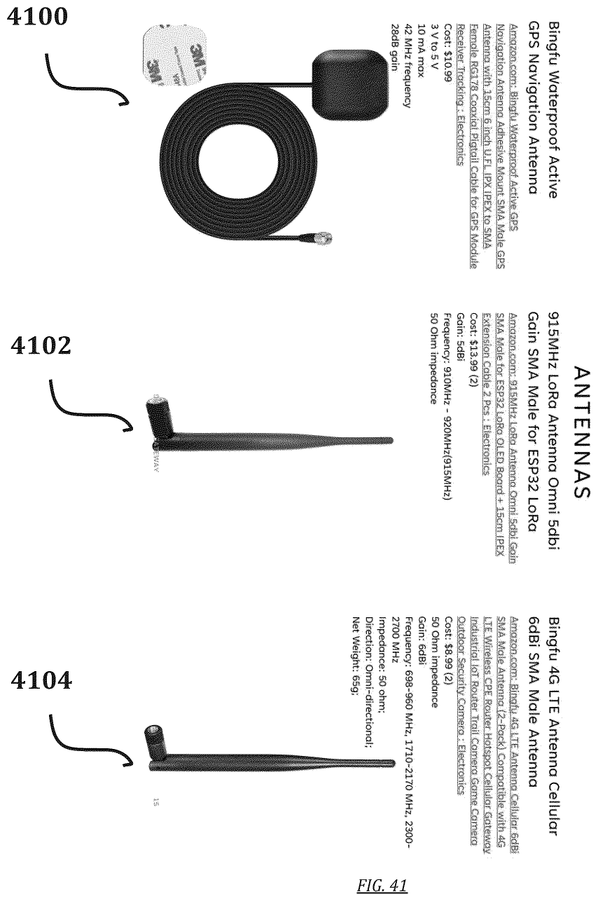

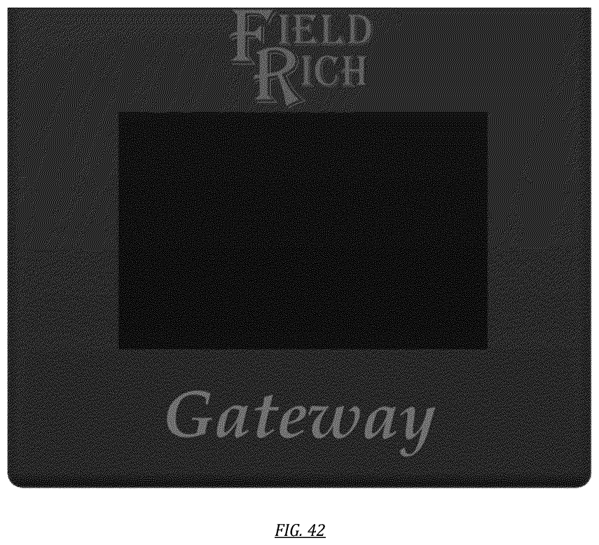

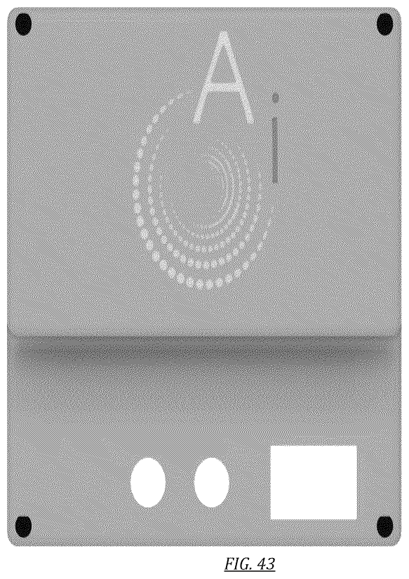

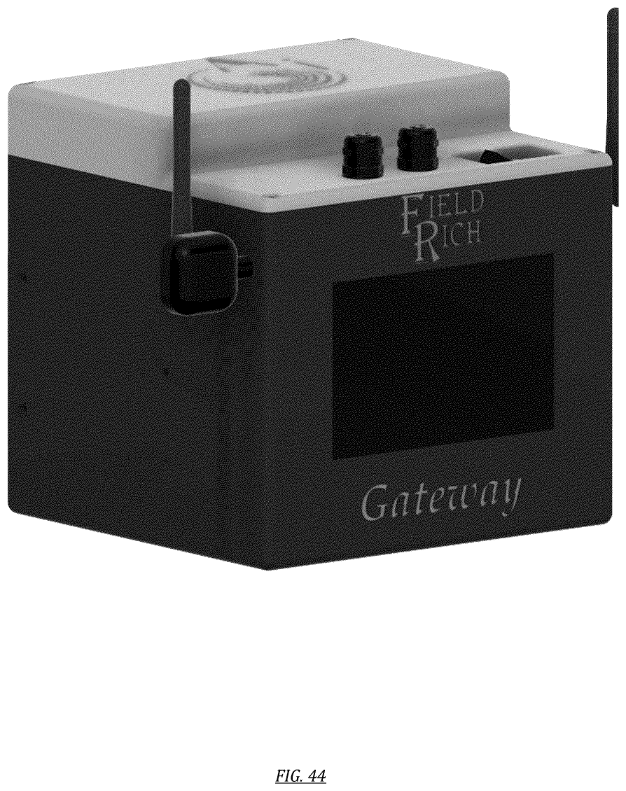

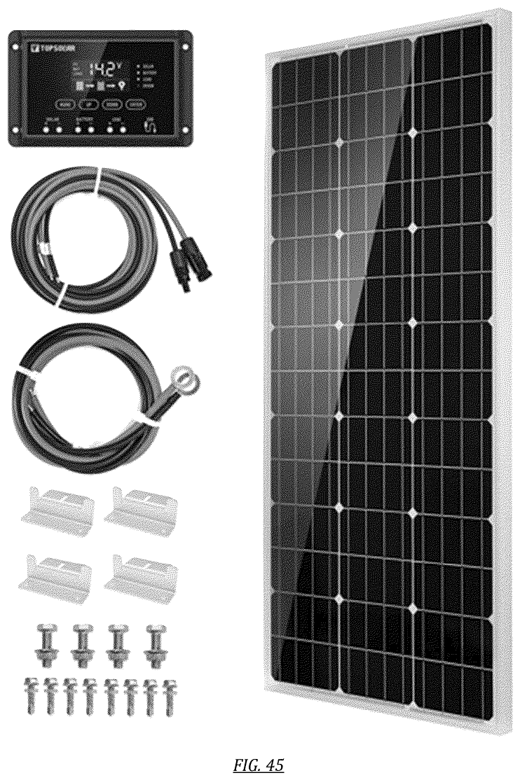

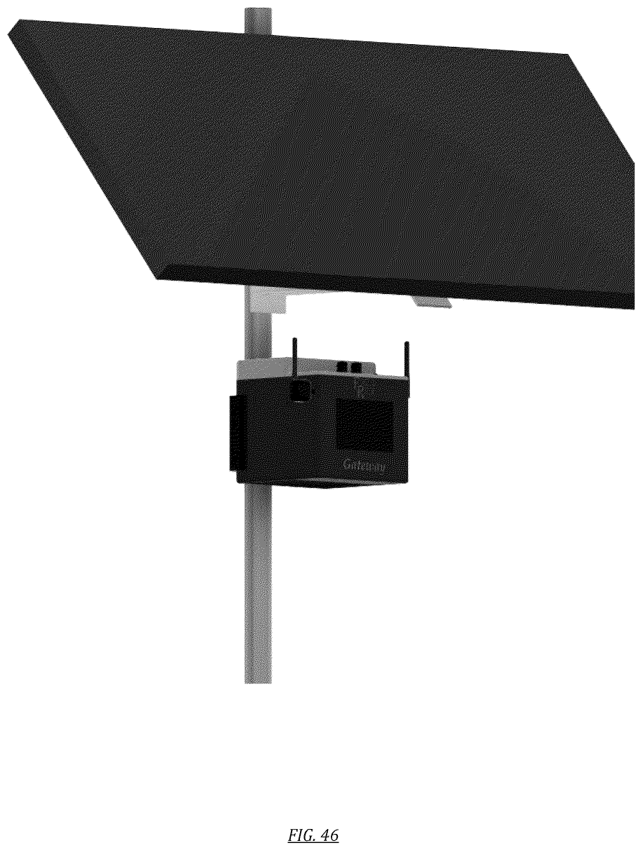

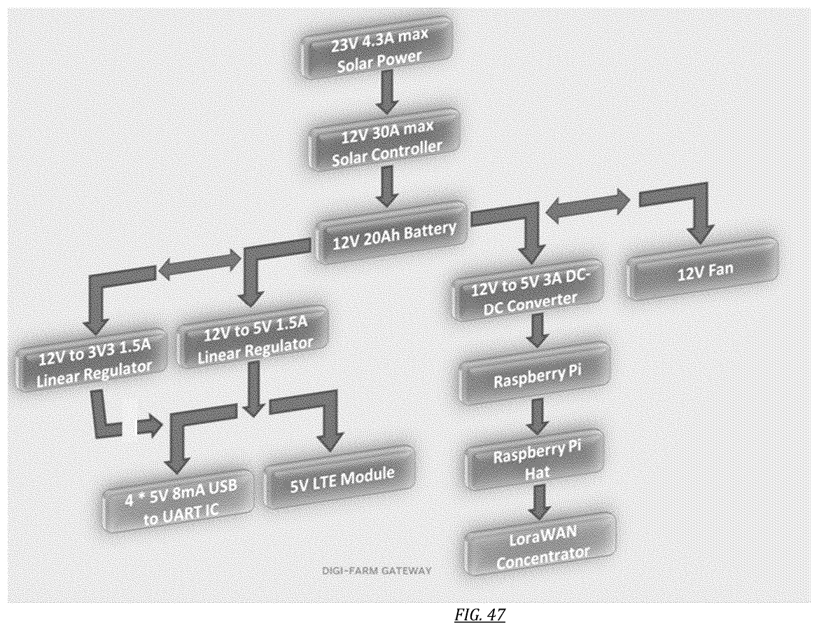

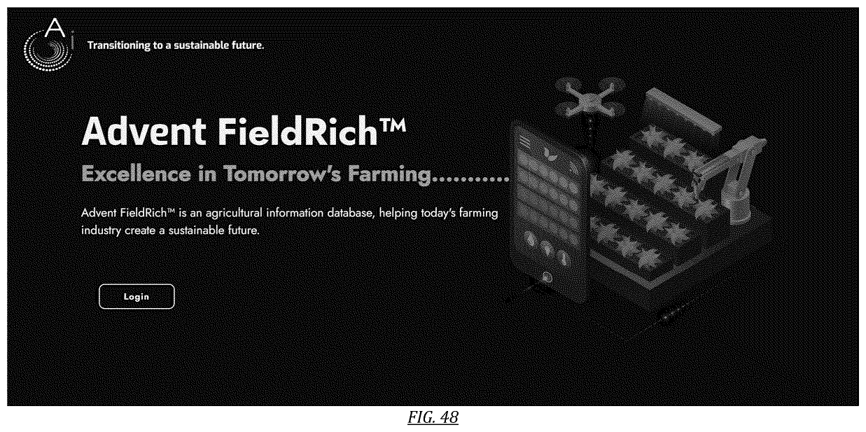

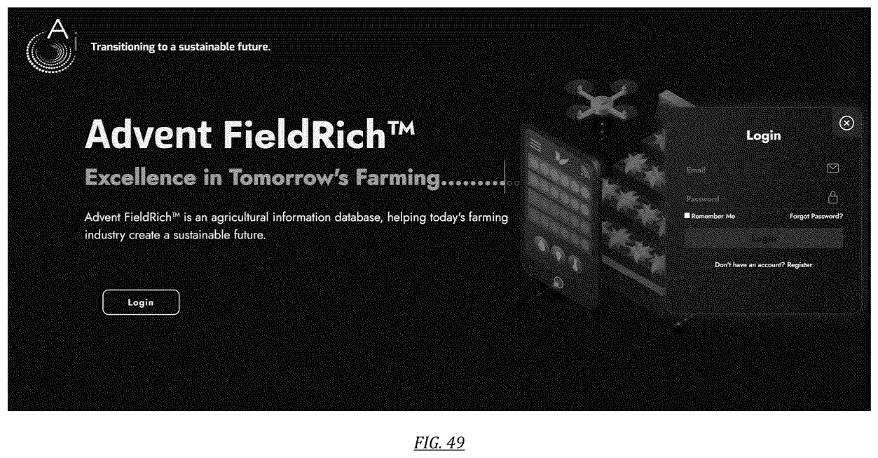

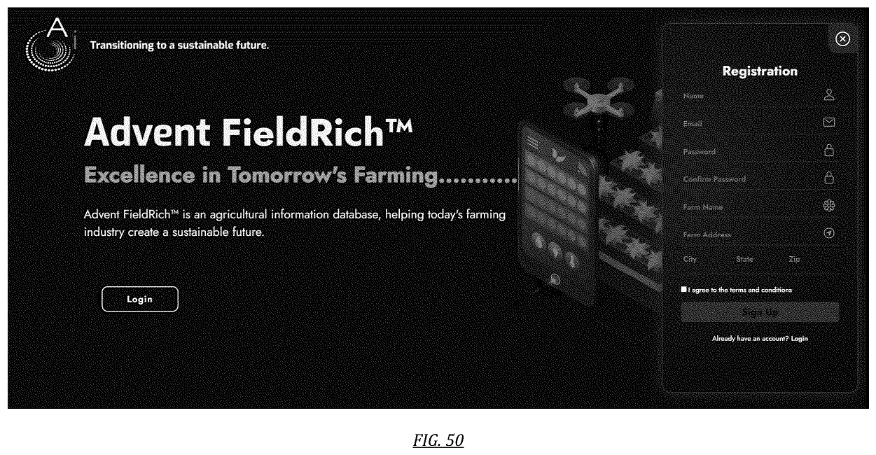

The electronics housed within the Gateway's main shell are detailed in FIG. 35. These electronics include an 8-35-volt to 5-volt 3-amp voltage regulator 3500, a solar charge controller 3502, a Raspberry Pi-powered LoRaWAN concentrator stack 3504, and a custom PCB 3506 for LTE connectivity. FIG. 36 details the Raspberry Pi-powered LoRaWAN concentrator stack's components which include a 4 GB Raspberry Pi 4 3600, a Raspberry Pi hat 3602, and a WM1302 LoRaWAN concentrator module 3604. A Bill of Materials (BOM) for the custom LTE PCB is shown in FIG. 37, its schematic is shown in FIG. 38, and a 3D model image is shown in FIG. 39. Some of the electronics that could be essential for the custom LTE PCB are detailed in FIG. 40. These electronics include a nano SIM connector 4000, a cellular LTE transceiver 4002, USB 2.0 receptacle connectors 4004, a 5-volt 1.5-amp voltage regulator 4006, a 3.3-volt 1.5-amp voltage regulator 4008, and a USB to UART integrated circuits 4010. FIG. 41 details the Gateway's GPS antenna 4100, LoRaWAN antenna 4102, and 4G LTE antenna 4104. FIG. 42, FIG. 43, and FIG. 44 show the front shell of the Gateway, top shell of the Gateway, and an image of the Gateway fully assembled, respectively. An possible solar power kit that continuously recharges the Gateway's battery is shown in FIG. 45. FIG. 46 shows a 3D model of a typical setup of the Gateway with the solar panel, and FIG. 47 details a power flow chart for the Gateway.

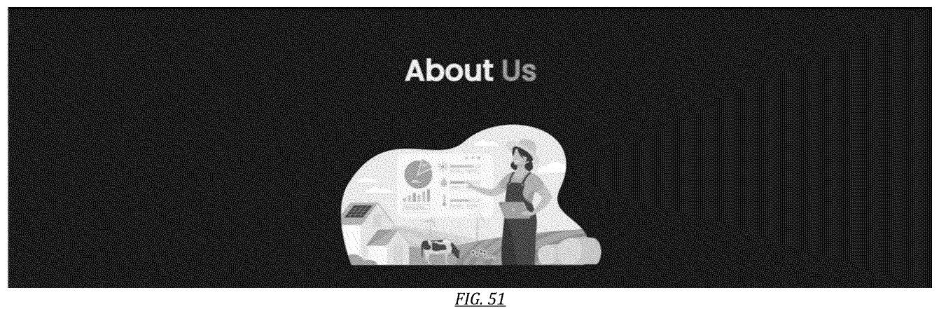

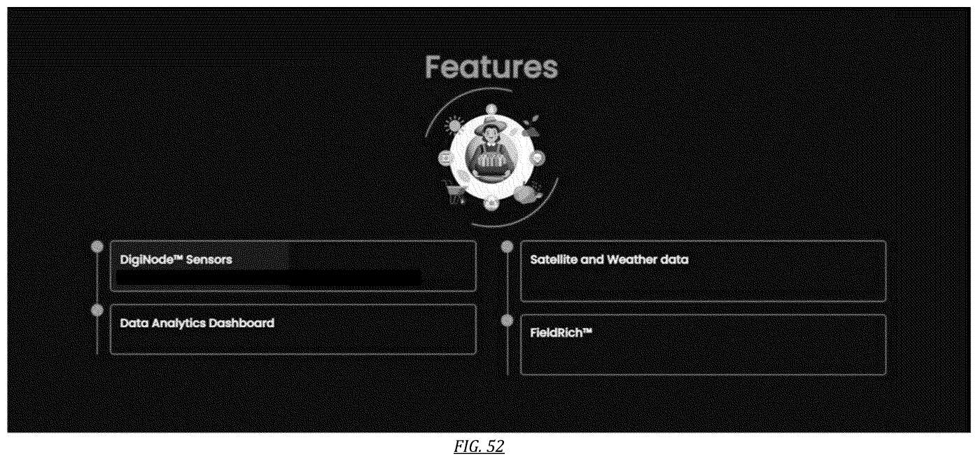

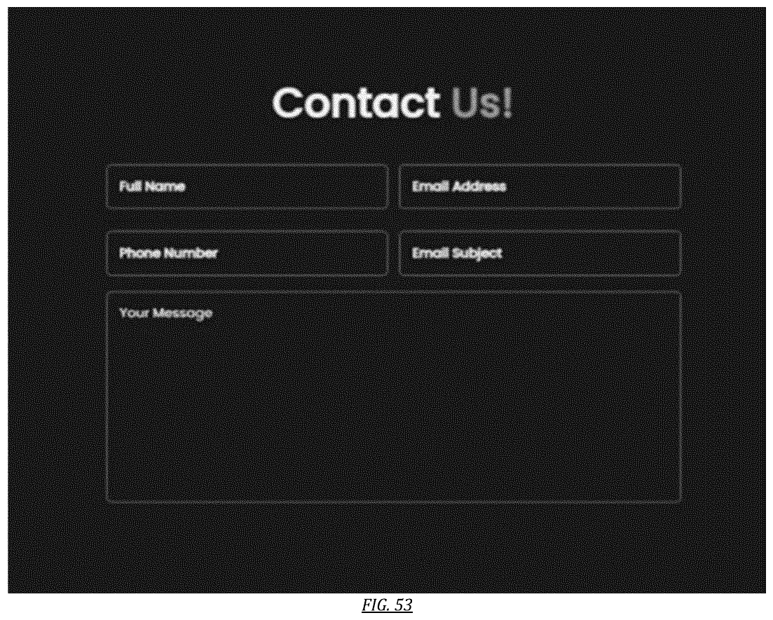

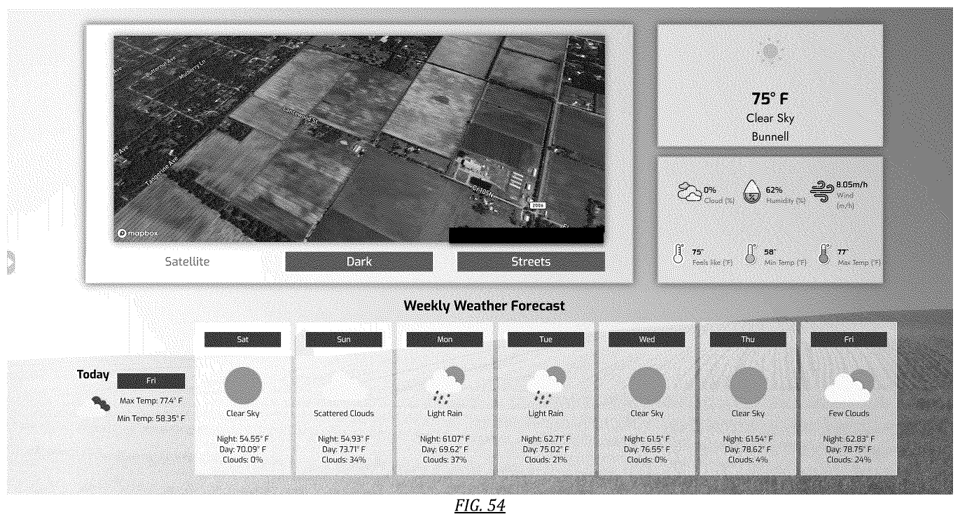

The Advent FieldRich platform includes an account-based website that allows users to access the DigiNode sensor data in real-time and for however long the Nodes have been active. This website portal provides the user inputs specific information about their farm including name, location and other personal information. Once the user has registered their account, the website will automatically personalize the information around the user's inputs. This information includes the farm name, current weather data at that location (provided by both apple and openweather-api) and any and all DigiNodes that the user has purchased and installed within their field. See FIG. 48-54.

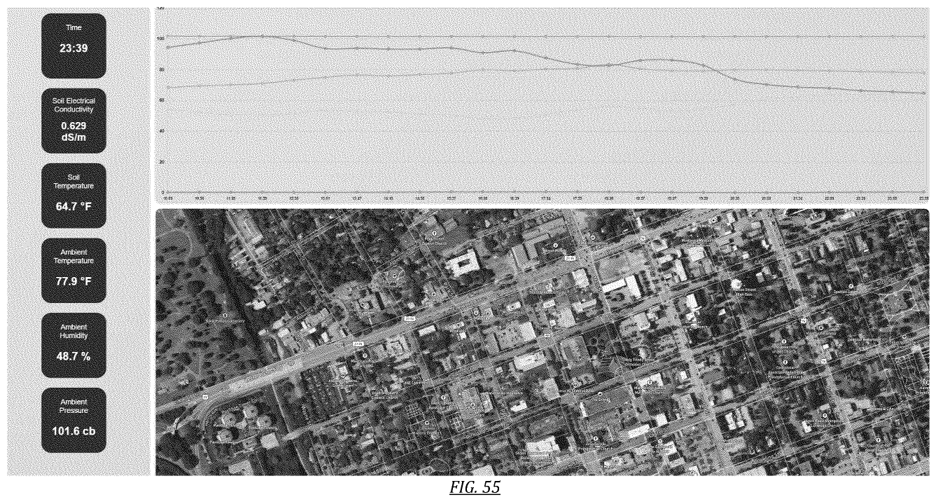

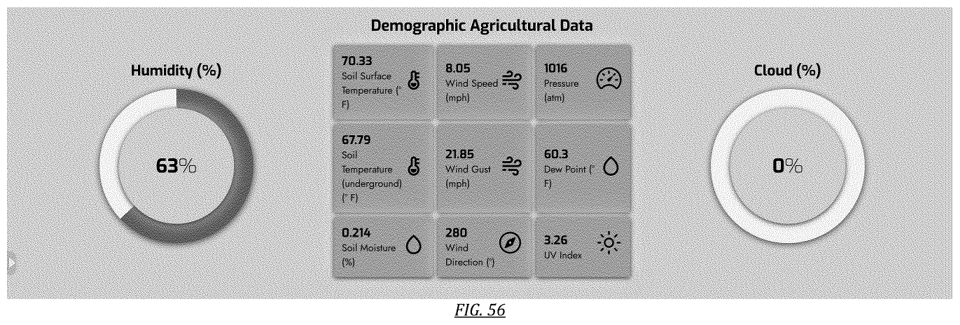

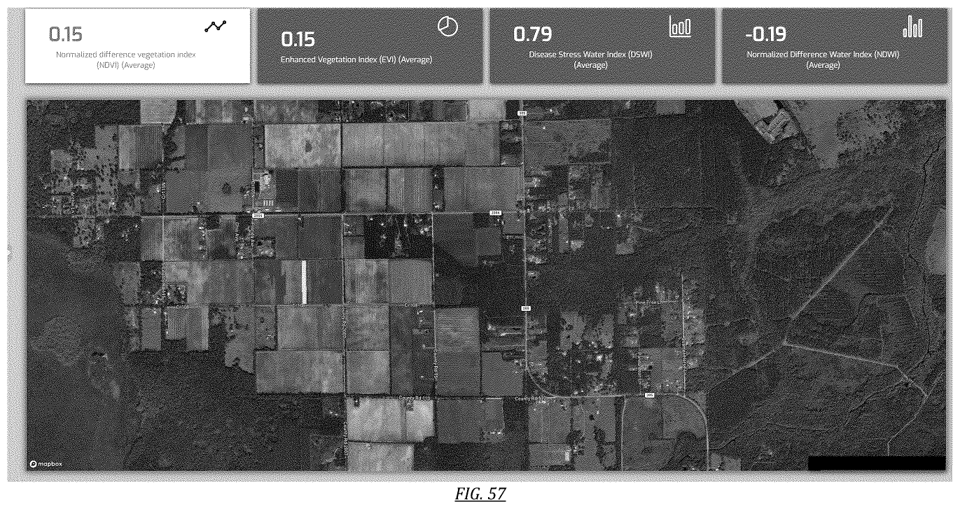

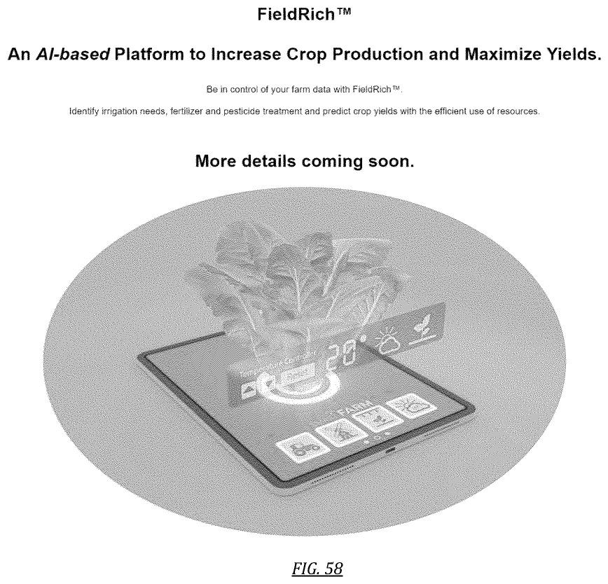

The FieldRich portal will relay all current and previous DigiNode data including ambient temperature, ambient light, ambient pressure, soil moisture, soil electrical conductivity, ground/soil temperature and ambient humidity. These values are displayed in charts as shown in FIG. 55 on a per day basis with the ability to select previous days (if available) and for whichever nodes that have been installed. This page also shows the most recent data collected by the DigiNode with all its data organized by the time it was received.

Apart from the visual interpretations of the data, another purpose of FieldRich is to further assist the farmers with their field maintenance. FieldRich includes with it an artificial intelligence software module customized for different crops, that will better analyze and interpret the various data collected by the DigiNode and train them using advanced machine learning algorithms, for the purpose of predicting overall crop yields for the season while providing suggestions on how to improve the field health daily and increase farm yields.

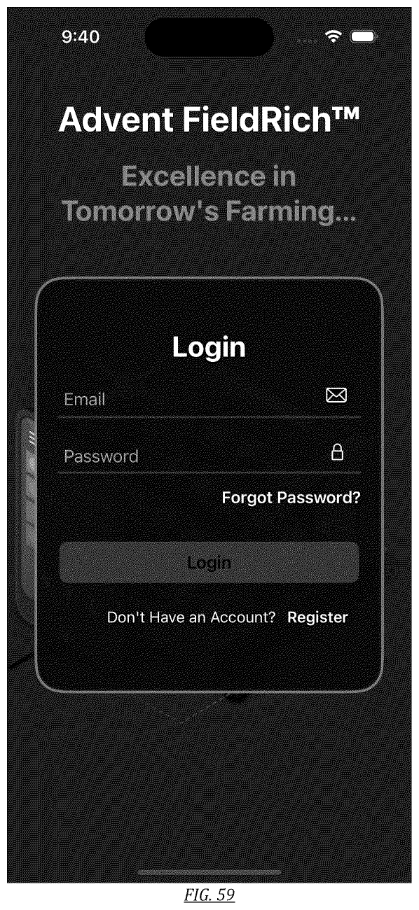

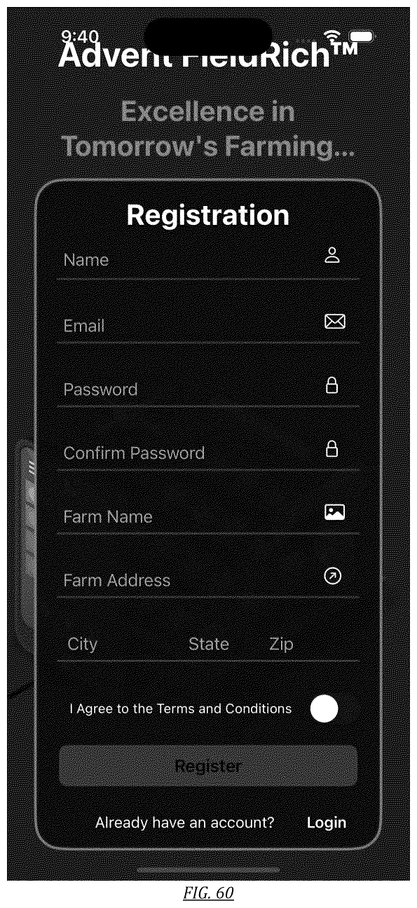

The FieldRich portal provides agro-informatics where, by request, the user can see satellite data on a specific field of their choice, this data includes a normalized difference vegetation index (NDVI), enhanced vegetation index (EVI) disease stress water index (DSWI) and a normalized difference water index (NDWI) as well as other environmental information including, but not limited to, soil temperature, wind speed, pressure, ambient temperature, wind gust, wind direction, UV index, dev point and soil moisture (See FIG. 56-57). This page also provides hourly and daily weather predictions at the location specified by the user during registration.

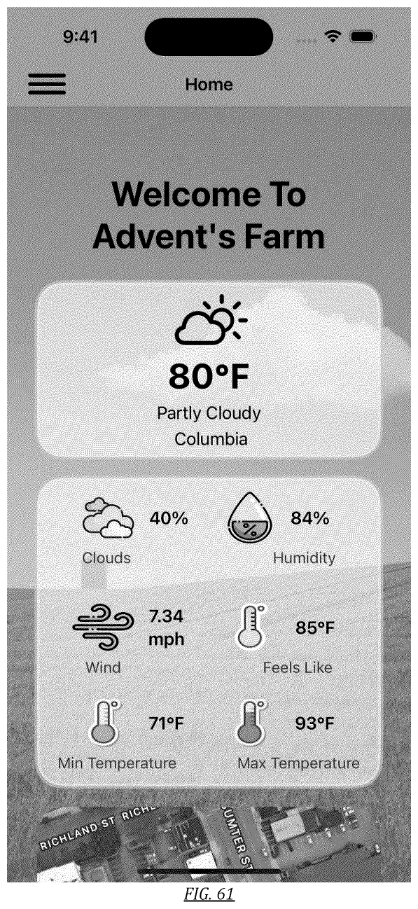

The FieldRich portal also provides a store (See FIG. 58) where registered users can access various products and see updates on new innovations related to FieldRich and its various product lines. Users will also have the ability to directly purchase products including hardware and software that will enhance the user experience.

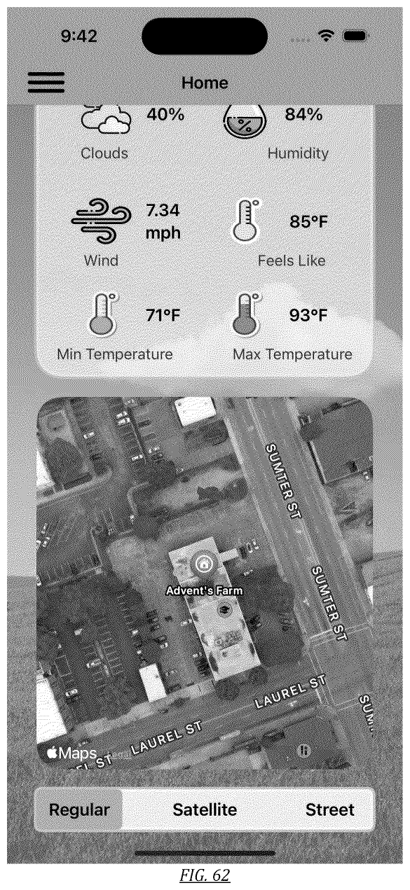

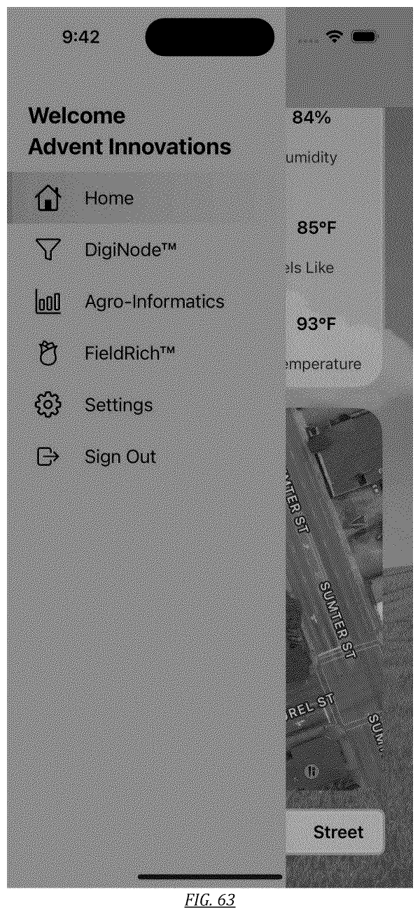

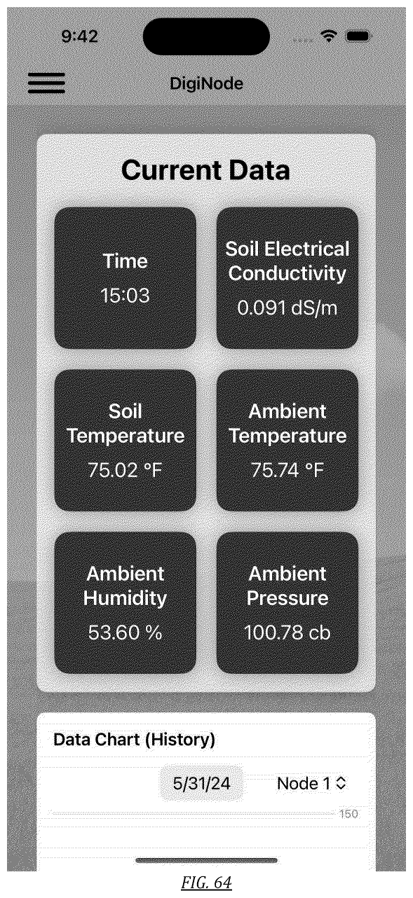

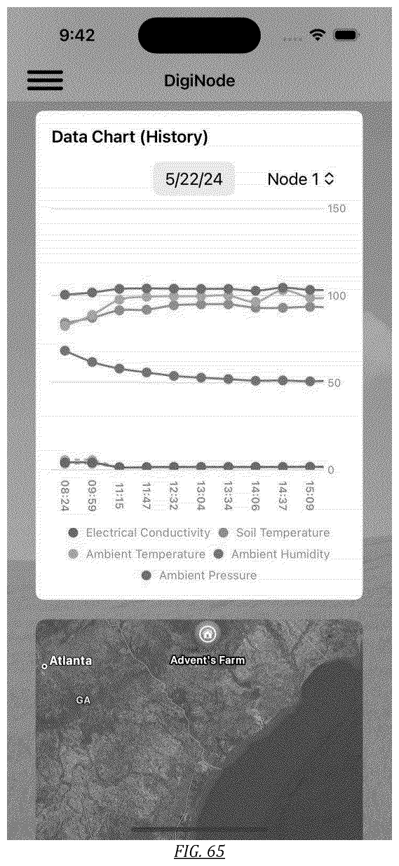

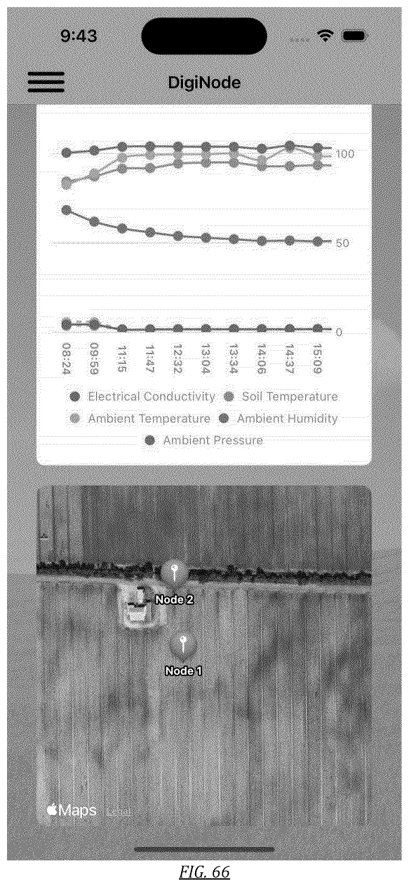

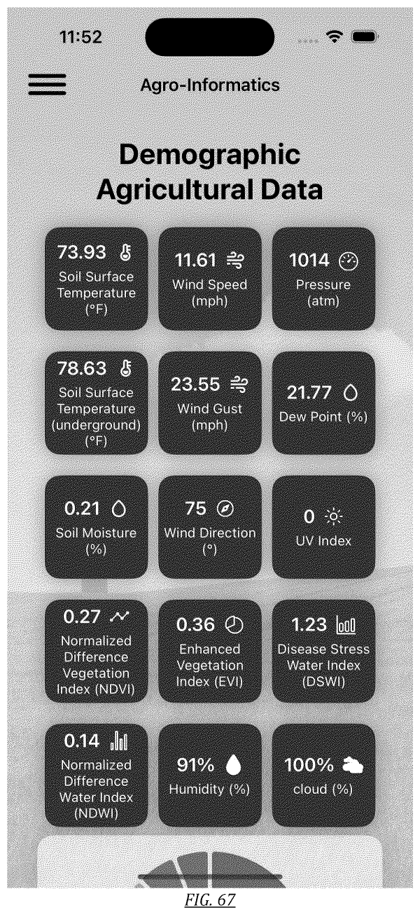

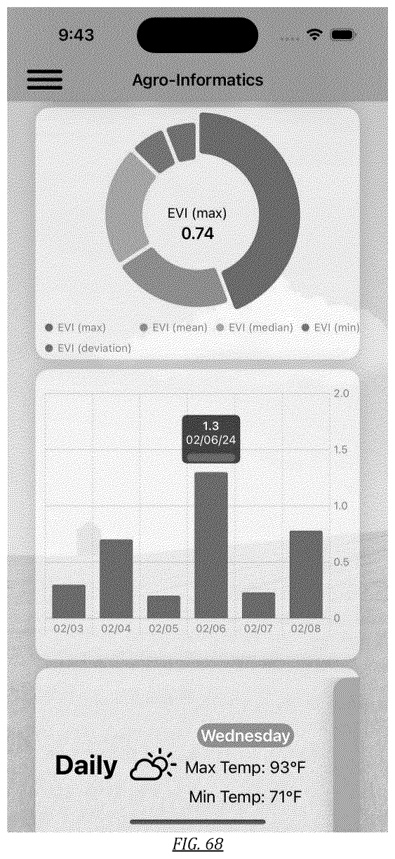

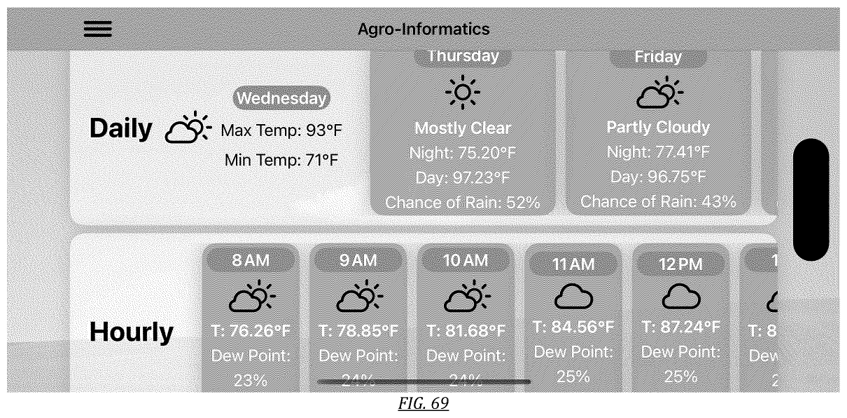

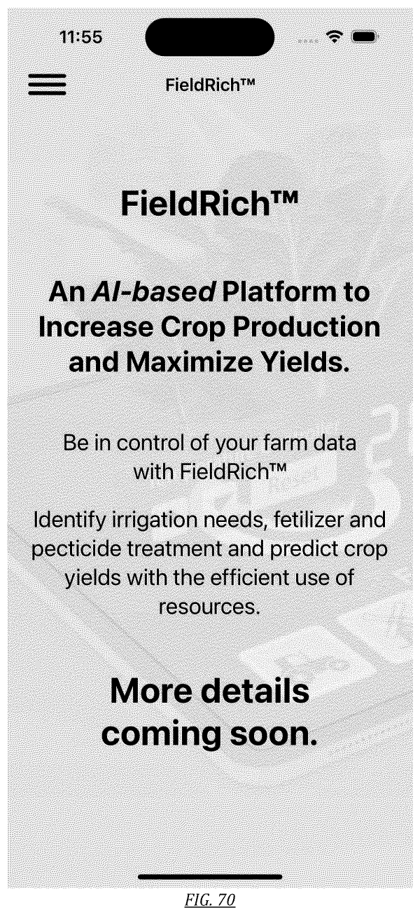

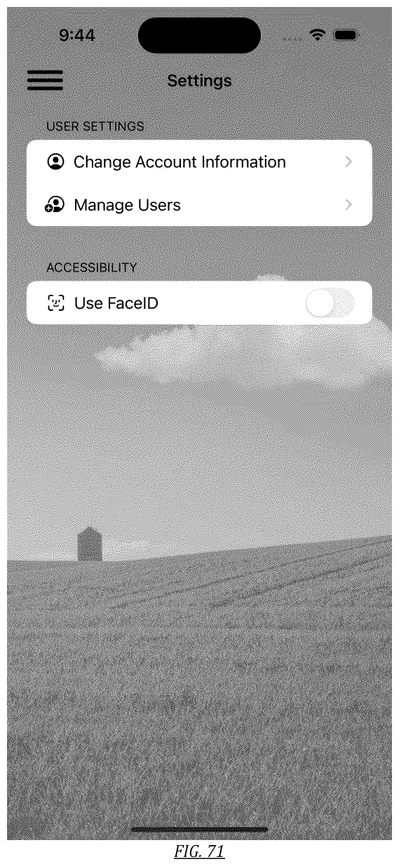

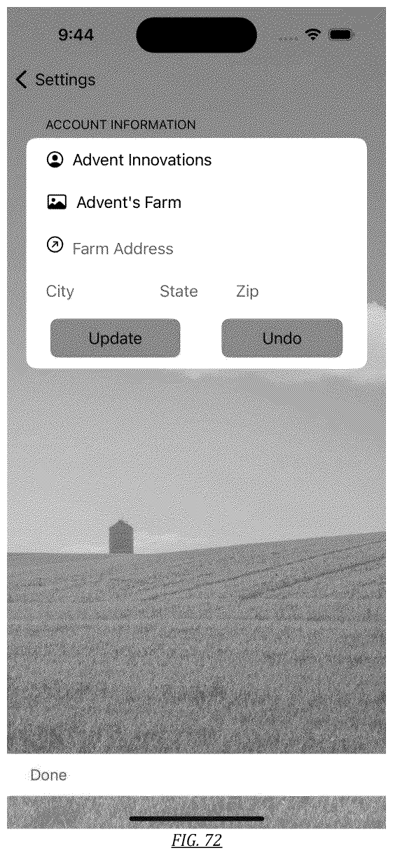

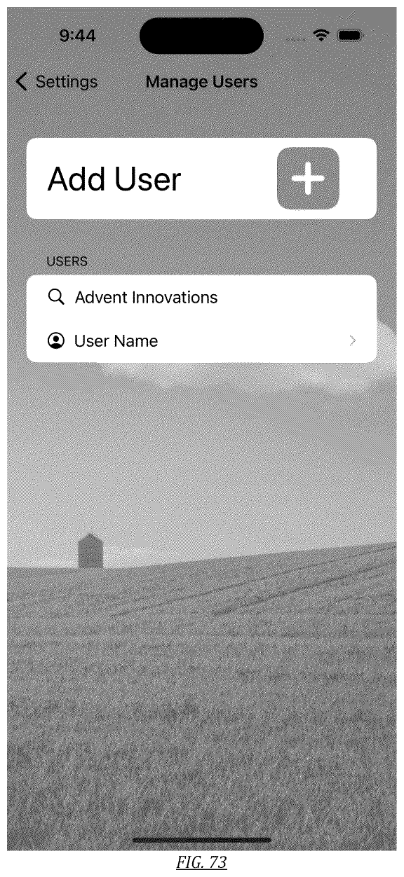

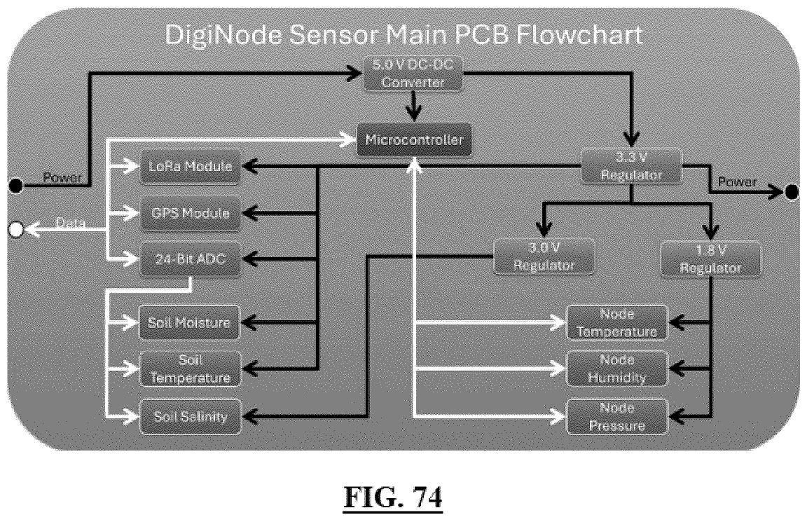

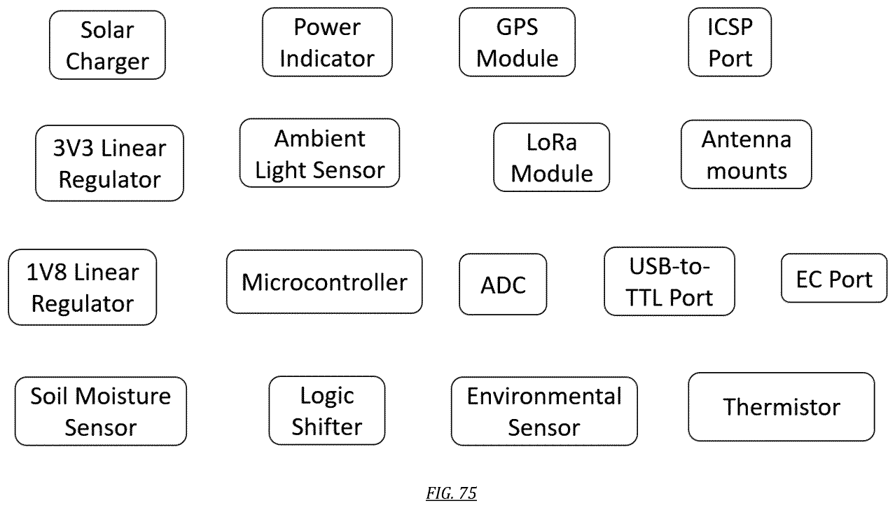

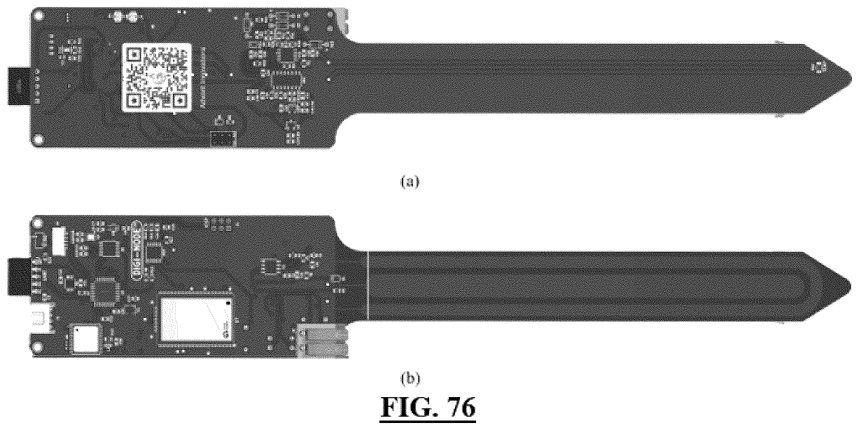

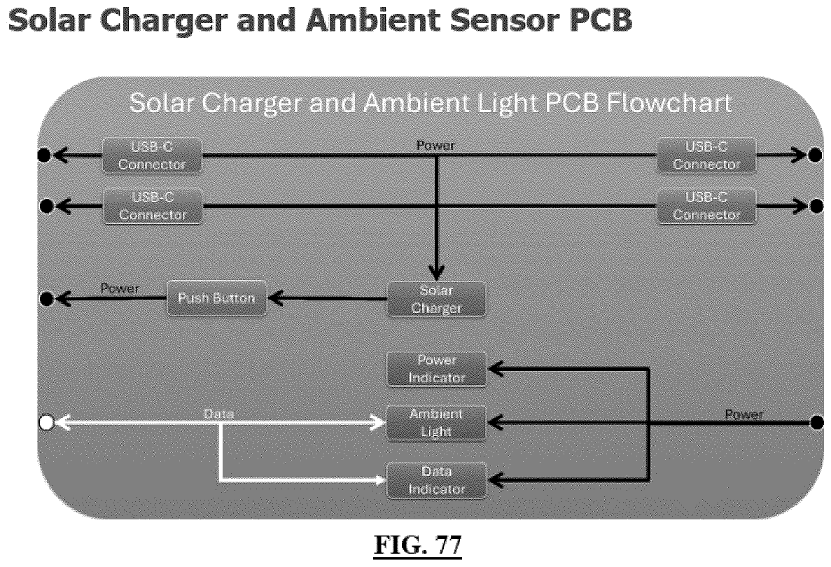

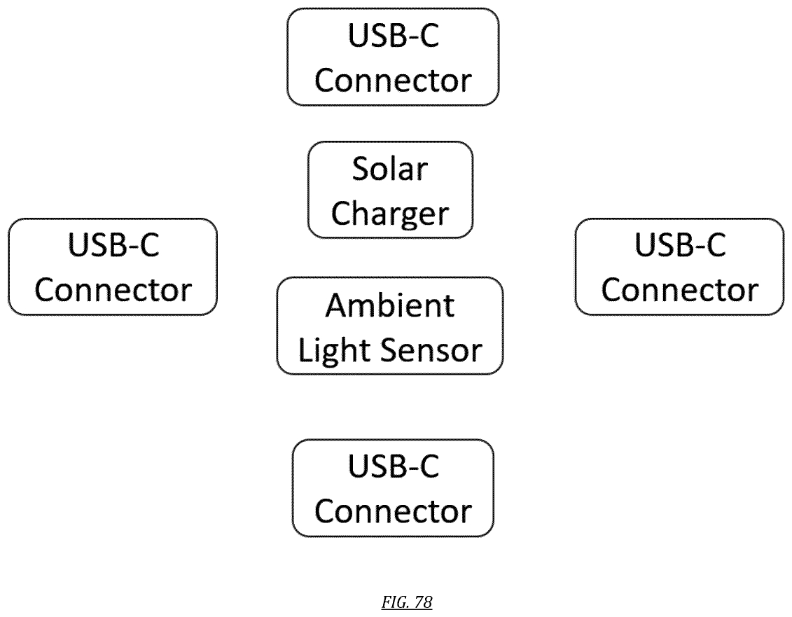

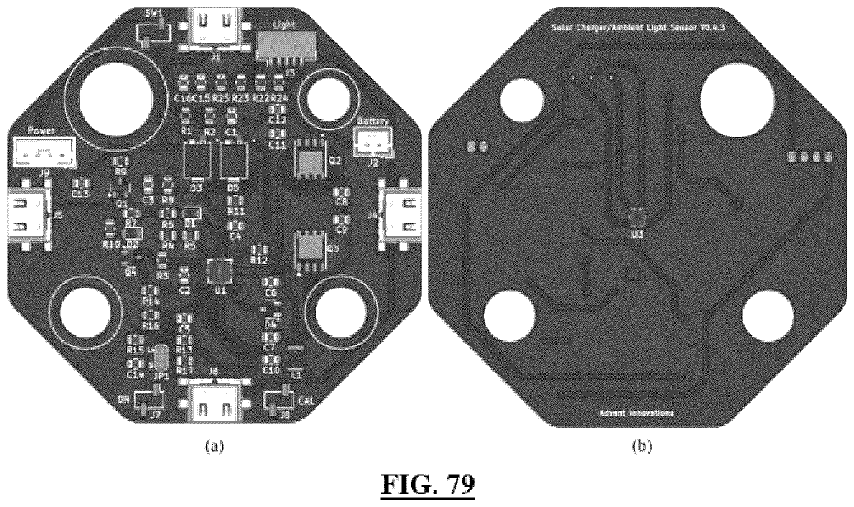

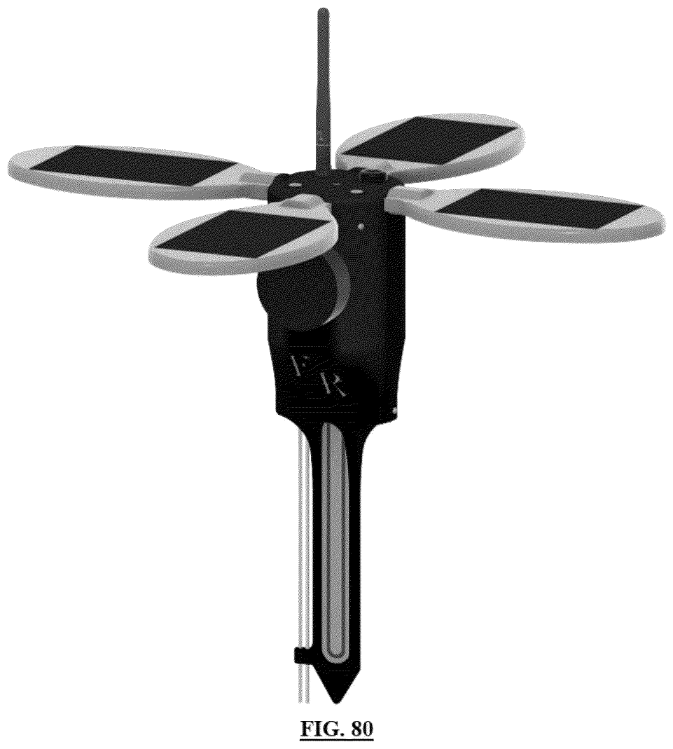

The FieldRich mobile application mirrors both the design and functionalities of the FieldRich website. The applications access an API that pulls from the database and will personalize the look according to the data the user has input within their account. The app is available for both IOS and Android. See FIG. 59-73.

To enhance the performance of the microcontroller within agricultural applications, a 5V DC-DC buck converter has been integrated into the system. This converter ensures stable voltage regulation and demonstrates improved power efficiency essential for sustained operations. In tandem, a 16 MHz crystal oscillator has been incorporated as a precise and reliable clock source, facilitating elevated processing speeds for time-sensitive tasks.

The system employs a capacitive soil moisture sensor circuit, which effectively monitors the volumetric water content of the soil. Unlike conventional resistive sensors, the capacitive design significantly enhances durability and offers superior resistance to corrosion. This capacitive sensor can be calibrated for various soil types, thereby ensuring accurate readings across a spectrum of compositions, from sandy soils to clay-rich substrates. Calibration is achieved through software-defined reference points, thus maintaining consistent performance across diverse agricultural environments.

To assess soil salinity levels, an electrical conductivity (EC) sensor circuit has been integrated into the printed circuit board (PCB). This sensor is designed to measure conductivity levels of up to 10 dS/m (decisiemens per meter) and employs a 24-bit ADC resolution to provide high-precision data, which is critical for monitoring nutrient levels and identifying potential salt accumulation. The circuit generates an alternating current (AC) excitation signal, which is applied across the sensor electrodes. This AC signal is essential for inhibiting electrode polarization, a phenomenon that can distort readings over time due to ion accumulation at the electrode surface. By using AC excitation the system maintains stable and accurate conductivity measurements even during prolonged operation. Furthermore, the circuit design incorporates temperature compensation mechanisms, ensuring reliable readings amidst varying environmental conditions. A Phoenix Contact 11902972 Position Wire to Board Terminal Block has been employed to facilitate a simple connection solution for stainless steel probes utilized in EC measurements.

The GPS module has been upgraded to the u-blox MAX-MIOS, recognized for its high sensitivity and ultra-low power consumption as a GNSS receiver. This advanced module supports concurrent reception from multiple satellite systems, including GPS, GLONASS, Galileo, and BeiDou, significantly enhancing positioning accuracy and reducing time-to-first-fix. Its compact architecture and minimal energy demands render it remarkably suitable for remote sensing applications, where energy efficiency and precision geolocation are critical for operational success. Power provision for the system is managed via a Solar Charging and Ambient Light Sensor PCB, further integrating sustainable energy solutions into the design.

This interdisciplinary approach not only maximizes the functionality of the microcontroller for agricultural applications but also positions the technology as a frontrunner in precision farming solutions, aligning with contemporary demands for sustainable and efficient agricultural practices. In contrast to traditional resistive sensors, the capacitive design presents increased durability and corrosion resistance. This sensor can be calibrated for diverse soil types, ensuring accurate readings across various compositions ranging from sandy soils to clay-rich substrates. Calibration is accomplished through software-defined reference points, thereby ensuring consistent performance within varied agricultural settings.

The present disclosure pertains to an innovative solar charger and ambient light sensor printed circuit board (PCB) that significantly enhances the DigiNode system architecture. This advancement is characterized by the decoupling of the power management subsystem from the sensor framework, thereby facilitating a modular approach conducive to simplified assembly, disassembly, maintenance, upgrades, and troubleshooting. Such enhancements also contribute to the overall scalability of the device. The disclosure falls within the domains of renewable energy systems, energy management technologies, and sensor integration.

The solar charger and ambient light sensor PCB features bi-directional communication with the main PCB through the integration of two wire harnesses, which provide rapid and secure electrical connectivity. A dedicated JST connector has been incorporated to facilitate direct plug-in of a 10-Amp lithium polymer (Li—Po) battery, ensuring reliable power delivery and easy replacement procedures.

A notable innovation of this disclosure is the incorporation of four USB-C power input connectors, specifically engineered to interface with solar leaf modules. Each solar leaf consists of a leaf-shaped mount embedded with 5V solar cells, thereby permitting the rapid deployment and removal of solar panels. This design supports flexible energy harvesting configurations, thereby optimizing operational performance in outdoor environments. The utilization of the USB-C interface further guarantees robust mechanical coupling and standardized power input across varied components.

The PCB design is augmented by precision-drilled mounting holes, facilitating the installation of two indicator light-emitting diodes (LEDs), a power switch, and a LoRa antenna. To enhance mechanical reliability and minimize wire clutter, the LEDs and power switch are interconnected via surface-mount solder pads, effectively eliminating the necessity for loose wiring and simplifying the assembly protocol.

Furthermore, the onboard solar charging circuit is engineered to deliver up to 1.2 A of charging current to the Li—Po battery, promoting rapid and efficient energy replenishment. The charging circuit is equipped with built-in overcharge and undercharge protection mechanisms, safeguarding the battery against voltage extremes and thereby prolonging its operational lifespan. In addition, the integrated ambient light sensor provides real-time illumination data, which can be harnessed to optimize solar charging performance or to trigger environmental responses within the DigiNode system.

This inventive concept represents a significant advancement in solar energy utilization and system integration, providing a robust framework for enhanced performance and a user-friendly experience.

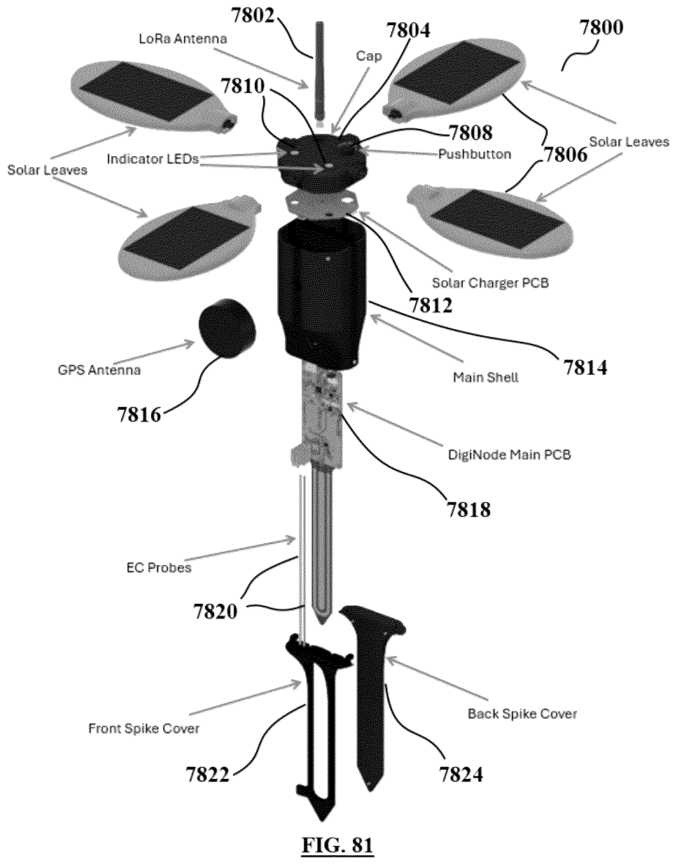

FIG. 81 shows an exploded view of a further embodiment of a DigiNode Sensor of the current disclosure. Sensor 7800 may include LoRa antennae 7802, cap 7804, solar leaves 7806, pushbutton 7808, indicator LEDs 7810, solar charger PCB 7812, main shell 7814, GPS antenna 7816, DigiNode Main PCB 7818, EC Probes 7820, front spike cover 7822, and back spike cover 7824.

Further, software updates may also be incorporated into the current disclosure. For instance, Gateway Software: Fieldrich gateways may come with a new user-interactable web-based portal. This portal gives the user asses to:
Checking the gateway connection status
Configuring or connecting to WIFI networks
Monitoring or interacting with the background services
Ensuring proper parameters are set and basic user account controls.
User-Interface:
Login Page:

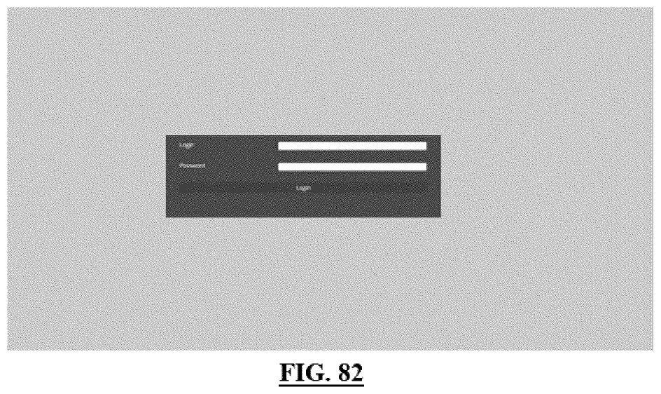

Login page, see FIG. 82, may include a login name and password that must be entered before accessing the gateway. Upon first purchase, login and password will be set to a default, sperate login can be used to access an admin version that allows edits to be available only to Advent personnel.

### Home Page:

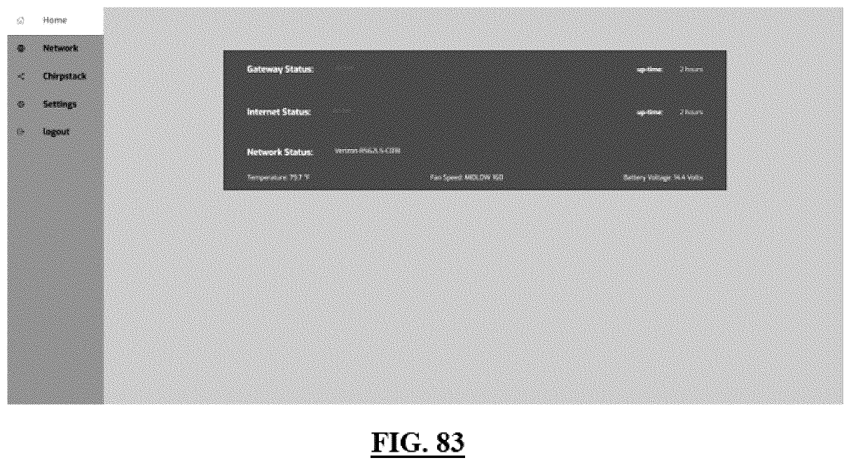

The home page may give quick feedback about the internet connection status, gateway connection status, network status including signal strength, and other important information including temperature, fan speed and battery voltage. Sec FIG. 83.

### Network Page:

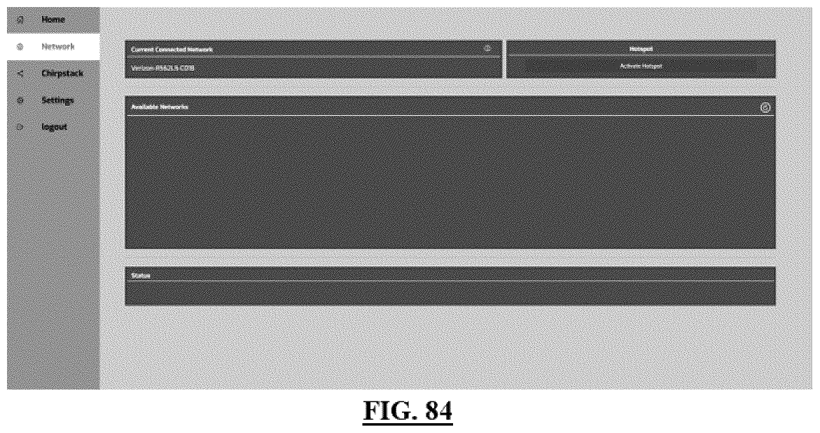

The Network page, see FIG. 84, allows the user to scan for WIFI networks or configure their network settings such as forgetting networks, getting the network IP address and getting the signal strength. The use can also activate the gateway's hotspot which is enabled by default allowing the user to connect to the gateway's access point for access to the web-based portal before a network connection is made or if one is no longer available.

### Chirpstack Page:

The Chirpstack page allows the user to navigate the different gateway configurations such as the LoRaWAN Chirpstack parameters. The MQTT settings and monitor the system services.

### Chirpstack:

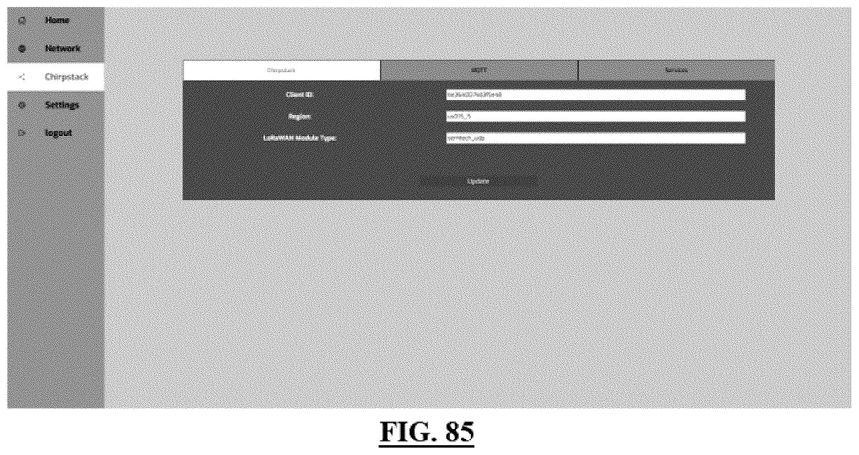

The Chirpstack page, see FIG. 85, gives access to the LoRaWAN Chirpstack parameters which include the client ID, Region and LoRaWAN module type. These parameters are used to inform our server as to which gateway is communicating and from what region. These parameters are Important for the DigiNode data to make it through to our server.

### MQTT Configurations:

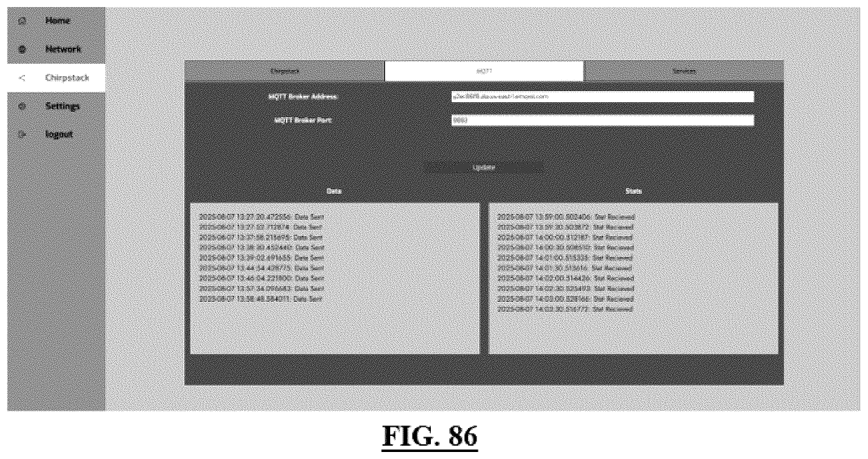

This page, see FIG. 86, allows the user to see the MQTT broker address and port value. The MQTT settings are in reference to a cloud based MQTT broker hosted by a third-party company called EMQX. The data and stats windows allow the user to view both the Diginode data and gateway stats that are sent to the MQTT server. These windows are primarily used to verify the DigiNodes are communicating to the gateway and that the gateway is attempting to communicate to our Chirpstack server.

### System Services:

This gateway operates on several system services that are background operations used for various purposes across the gateway. The first service is the fan service which is responsible for controlling the gateway's fan as well as the temperature sensor and monitoring the battery voltage. This is done by using a microcontroller mounted inside the gateway but connected to the internal computer through USB. The second service in use is the MQTT filter service, this service is used to filter the incoming data from the DigiNodes and forward the data into the EMQX cloud based MQTT broker. This service is also responsible for storing the Diginode data onto a MYSQL database hosted locally and is used for local data storage as a precaution protecting if the data fails to transfer to the cloud-based MQTT broker due to internet failure, etc. Next is the MQTT Terminal Service which is used for remote access to the gateway for any location. Provided the gateway has an internet connection, this service uses a third-party server called Tailscale that allows our company account to remote into all gateways for my remote location. Next is the LoRaWAN packet forwarder service, this service is responsible for the communication between the gateway and the DigiNodes. This service uses the LoRaWAN receiver to intercept the Diginode data coming in form the field. It captures the Diginode sensor data as well as the gateway's GPS location and passes this information into the MQTT filter service for local storage and transmission to our server. Finally, the last service, local storage service, is used to monitor the local storage, ensuring proper transmission of data to the cloud based MQTT broker and monitoring the local storage space. If the data is successfully transferred to the cloud-based MQTT broker, then the data is removed from the gateway, preventing an overflow of data storage. It also monitors the connection to the cloud-based MQTT broker and internet connection.

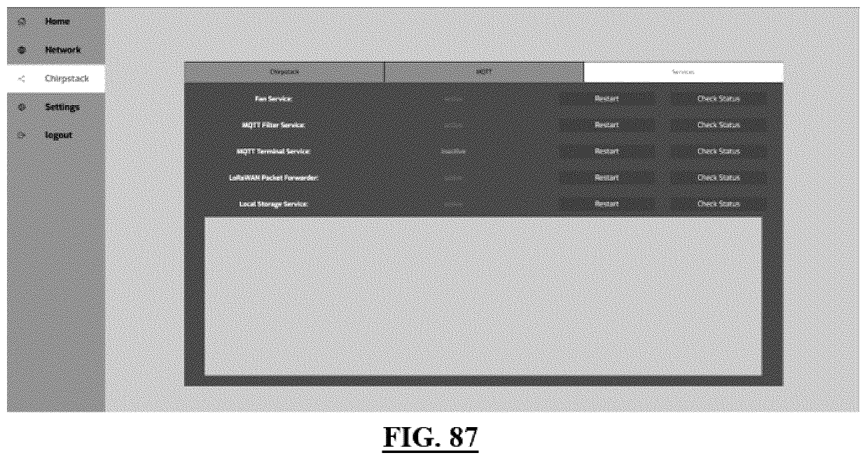

The user can choose to restart the service if needed or check the service's status to view the current service state. These services are programmed to restart automatically if failure occurs. See FIG. 87.

### Settings Page:

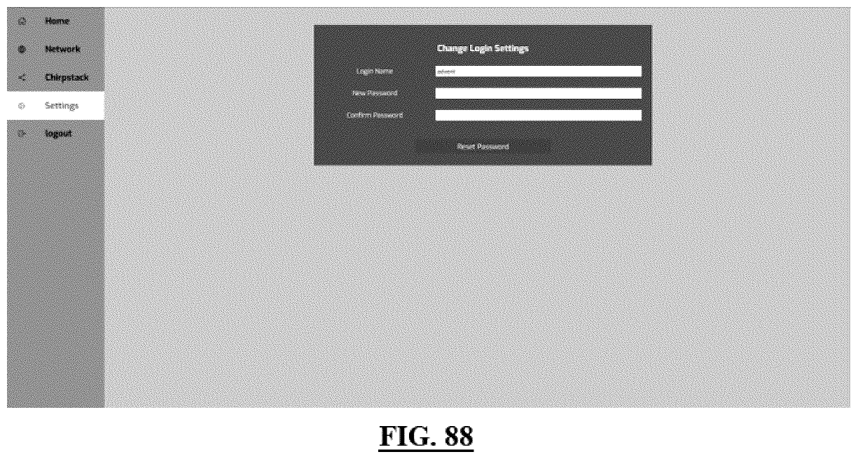

The settings page, see FIG. 88, shows a basic account-based settings page where

the user can change their login name and password for improved security.

### Fieldrich Software:

### Diginode V2 Page:

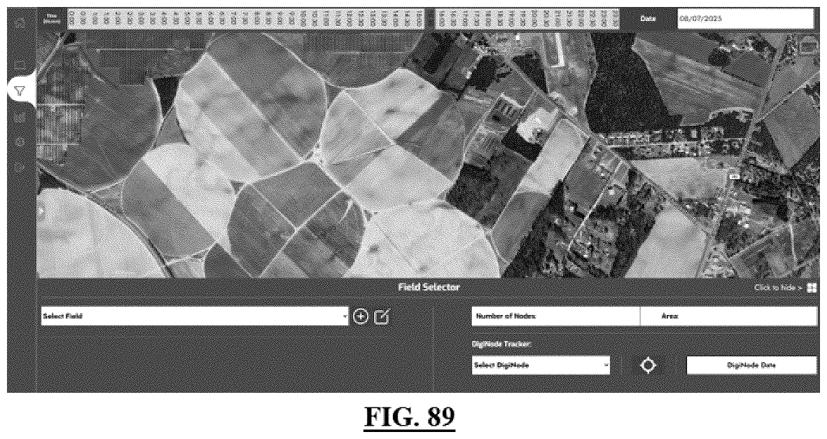

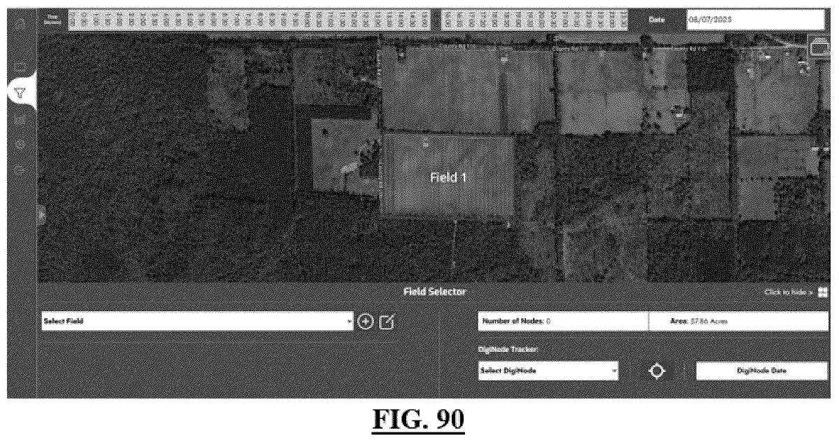

In this embodiment, the Diginode page, see FIG. 89, was completely reimagined giving the user a more interactive experience with new features including:
Interactive Main Window
Field Creation
Diginode Data Viewer
Surface Plot Visualization
Diginode Tracker
Alerts

Once the user clicks on the Diginode page, they are first greeted to a full map view of their farm. In the bottom right corner is an icon that when clicked opens the field selector window where the user can navigate to a virtual field or locate a Diginode using the Diginode tracker.

At the top of the screen shows the timeline and current viewing date. The timeline is separated by 30-minute intervals. The main map display runs according to the timeline and date selected. By default, the timeline will adjust to the most current date and time but if the user changs the date or time, the map will adjust to that current date, showing the Diginode locations are those dates and time on the map. This allows the user to navigate through the historical Diginode data.

Finally, on the top right, just under the timeline is the alerts system Icon currently showing the number of alerts active.

Upon first time use, the user should start by creating a virtual field around the area on the map where their DigiNodes are located. The user does this by clicking on the “add new field” button where they can then draw overtop of the map creating the boundaries of their field and giving their field a name. The user has full control over the creation, placement and name of their virtual field and can even rename the field after creation or delete the field entirely.

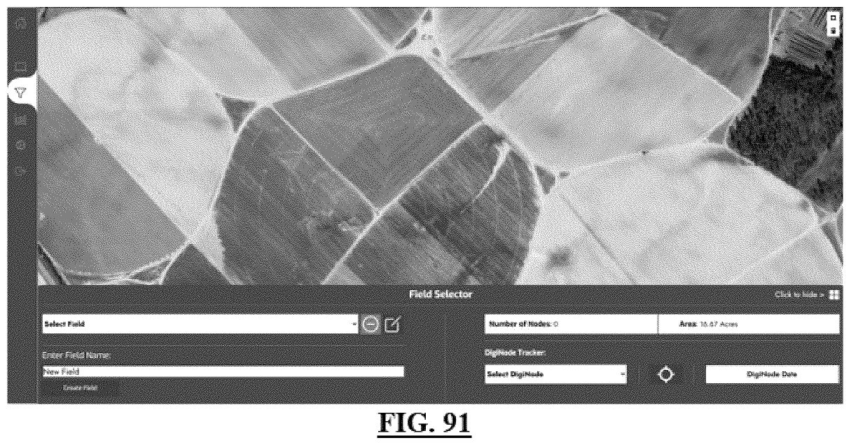

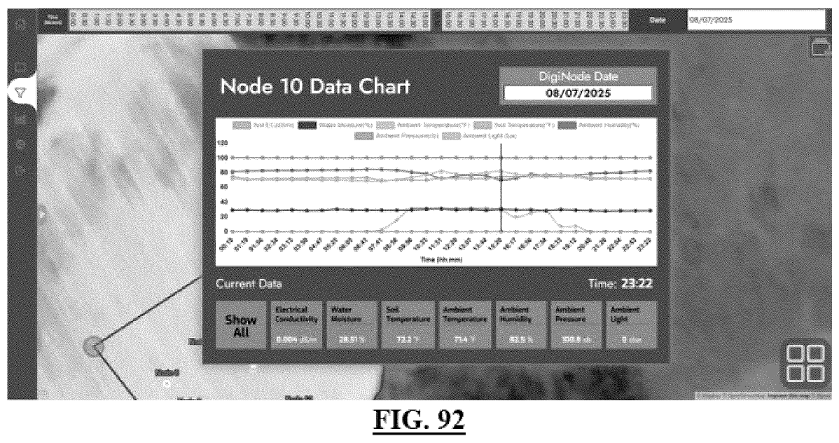

Each field that is created is stored in a MySQL database tied to their user account. There is no limit to the number of fields the user can create. The system operates internally on the data stored in the many databases tied to the user, the fields allow the systems to track the activity within the field and will begin to generate surface plot data for every field created. Shown in FIG. 91 is an example of the field creation screen.

As seen within the field selector on the right, the number of DigiNodes within the field will be calculated after the field is created as well as the area of the virtual field. This data is updated depending on the date selected. If the date is moved to a time before the DigiNodes were active the number will drop to zero. This feature is used for convenience to always know how many DigiNodes are active during their deployment on a day-by-day basis.

### Diginode Plot Viewer:

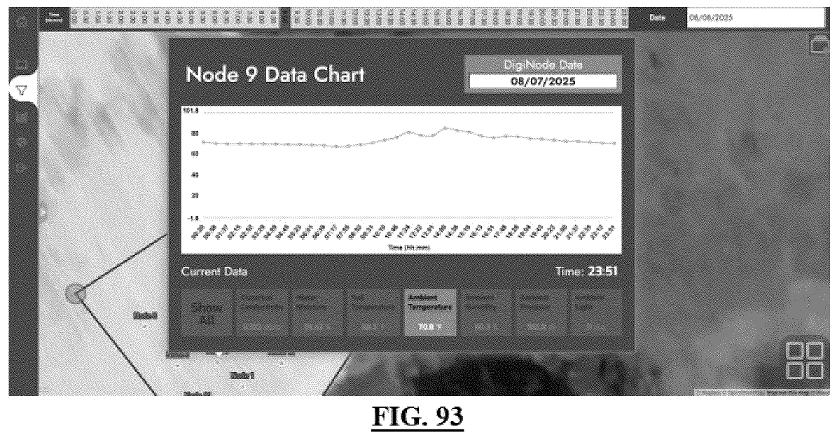

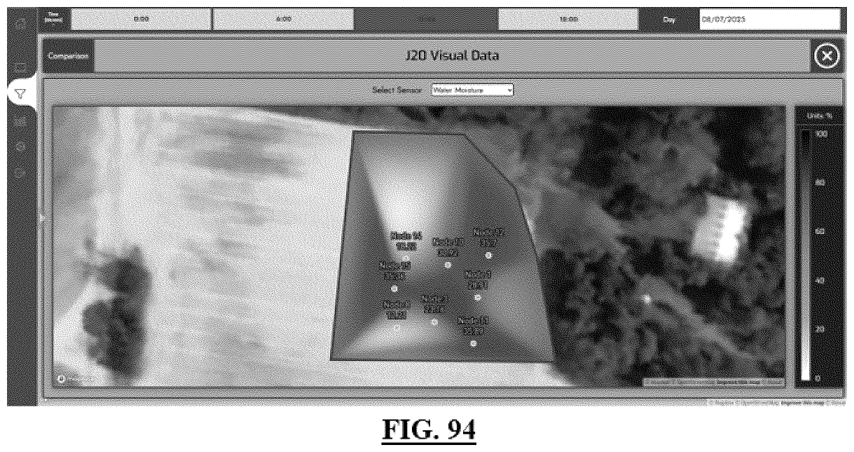

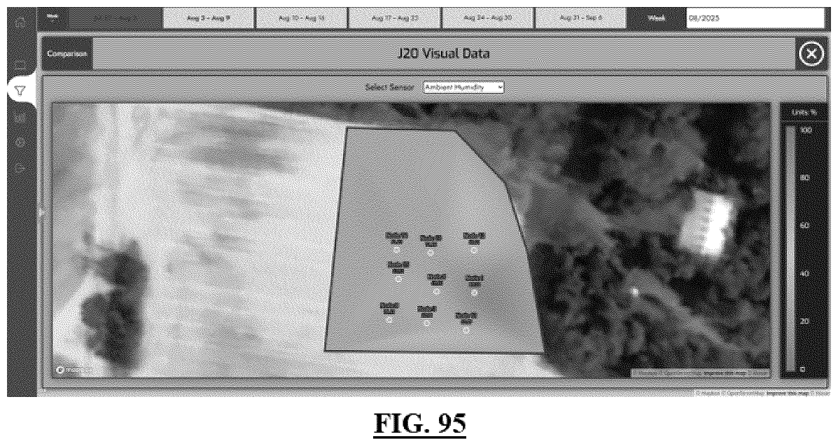

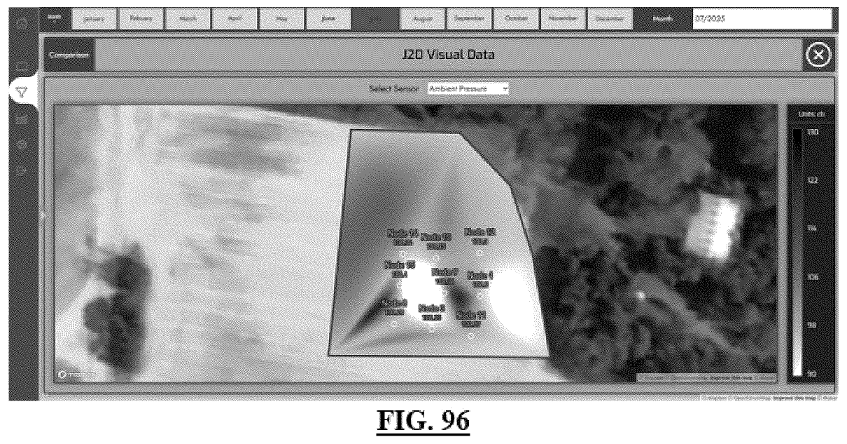

As illustrated in FIG. 92, if the user clicks on the Diginode icons displayed on the map, a window will appear showing the data of all 7 sensors for that Diginode icon that was clicked. Each Diginode icon is labeled by a unique number, and the plot viewer will always display they Diginode that was selected at the top left of the window. On the top right is the Diginode Date selection. This displays the current date that the user has selected for the current Diginode they have selected. This date viewer will only allow the user to click on dates that the Diginode has data for, excluding all dates that do not have data. This provides convenience to the user, helping to ensure easy navigation through the historical data collected by the Diginode. The plot in the center of the window shows all of the data for the current selected date with a green bar showing an approximation of the time in which the Diginode collected data within the time interval selected on the timeline. The plot allows the user to select the sensor data in the legend, enabling or disabling them in the plot allowing for an easier time comparing specific sensor data plots. The user can also click on the buttons at the bottom of the view to only show the specific data plot of interest, an example of this can be seen in FIG. 93 below. The data shown in the green button always show the current data of the Diginode and the current time in which the most recent data was collected.

### Surface Plot Visualization:

For every virtual field created, displayed on one of the corners on the field is a circular colorful icon that when clicked opens the visual data window. Inside this window is shows the virtual field with a colorful heatmap surface plot illustrating an estimation of the sensor values across the entirety of the field based on the values of the Diginode. This estimation is a cubic interpolation using an average value from the Diginode for each 6-hour interval starting from 12 AM. The interpolation is done for all 7 sensors for all the DigiNodes within a field. Each sensor can be selected form the “select sensor” drop down showing each sensor and a color bar on the right describing the units and values. Each of the estimated values for the DigiNodes are also displayed on the image with both the Diginode name and averaged values shown. Each sensor has a unique color map color to better fit the sensor's displayed values.

At the top is the timeline that allows the user to select between the 4 different timeslots where the image will be redisplayed corresponding to the time selected. If the time slot is highlighted green, this means that there is a map for that time slot available. If black, then there is not a timeslot, and the user cannot click the timeslot as there is no map to show. Depending on when the Diginode was installed or if the DigiNodes does not have sufficient data for the specific timeslot, the system will not generate a map and will wait for the next available opportunity or generate a map. Certain criteria must be met for a map to be generated including at lease three or more DigiNodes with at least one data point within the 6-hour range and the Diginode must be within the virtual field. The timeline also allows the user to select the date, viewing historical maps collected for the field, this date selection works similar to the Diginode date selector where only dates that have maps available are clickable, again making it more convenient to the user.

The timeline also allows the user to select the time frequency where it defaults to a day-by-day viewing but can be changed to a week-by-week or month-by-month. If the user selected a week-by-week, the timeline would adjust to show the weeks within the current month and will allow the user to see a map that describes the Diginode data averaged within the week instead of a 6-hour period. Similarly, the month-to-month works the same except the data is averaged across an entire month.

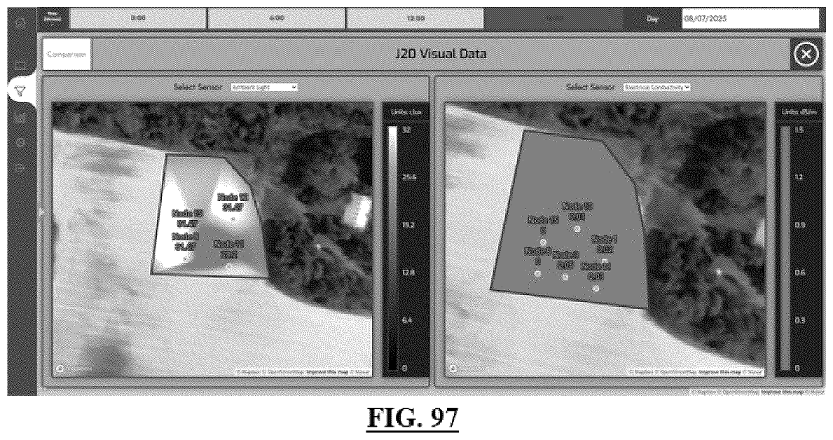

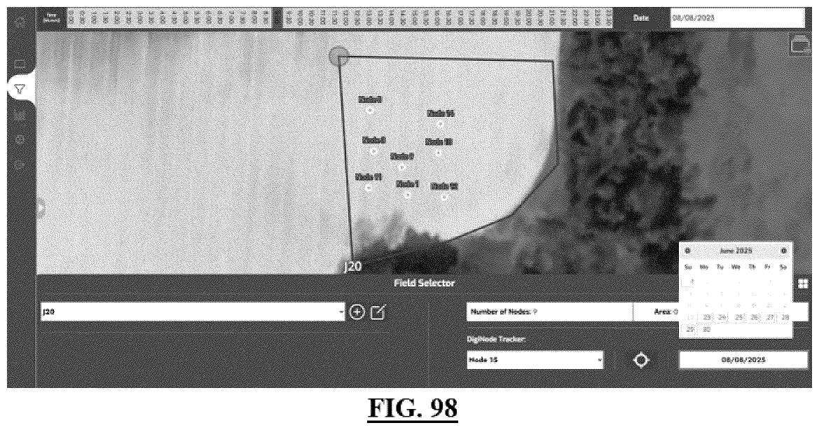

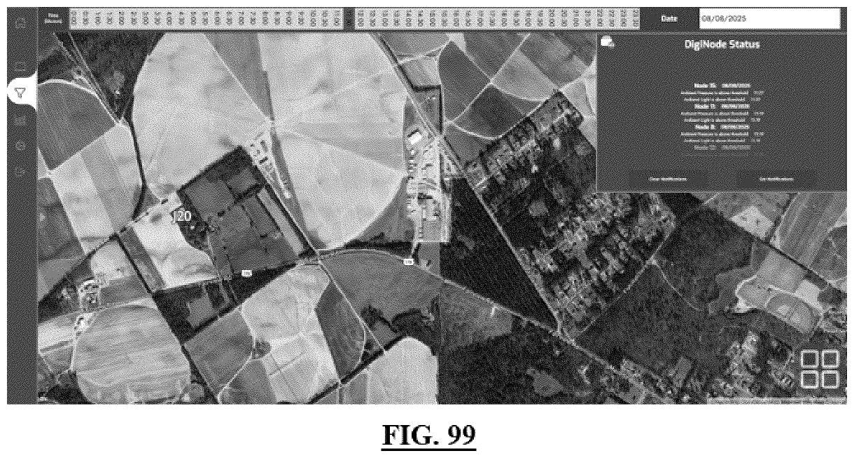

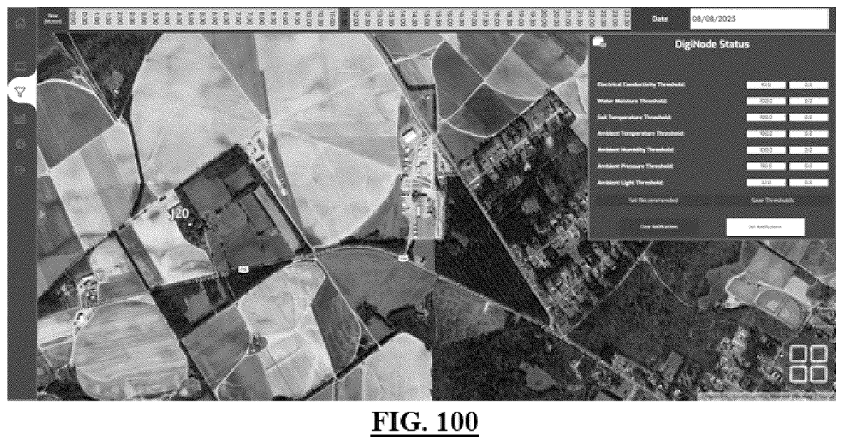

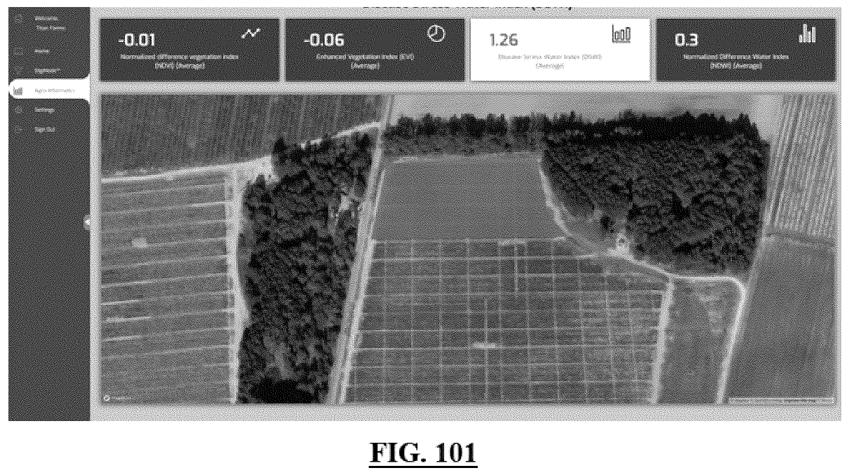

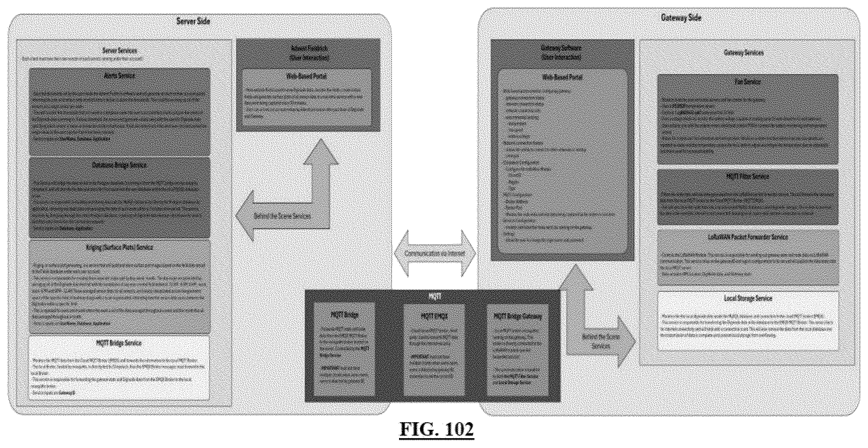

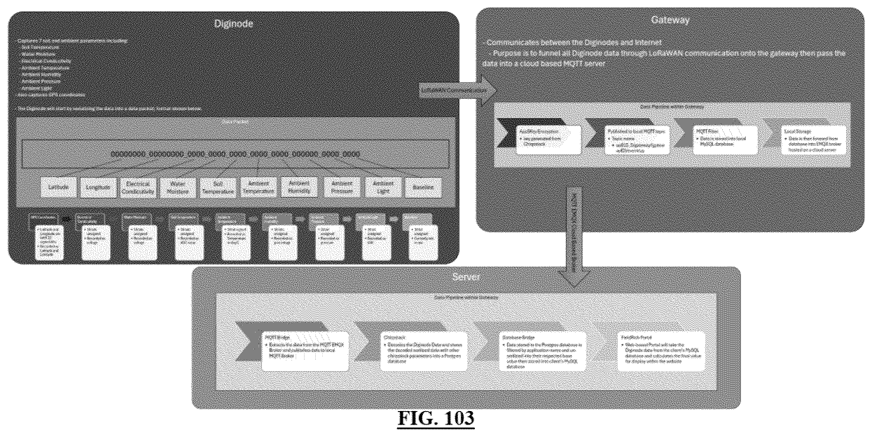

If the user clicks the comparison button, the window will change show two maps side-by-side where the user can select two separate maps allowing for comparison between two sensor values. This is a convenience feature that provides a way to see two maps at once. The limitation is the user can only see two maps for the specific day/week/month selected. An example is shown in FIG. 97.

### Diginode Tracker:

The Diginode tacker is a feature used to locate a specific Diginode anywhere on the map and within any date. First the user starts by selecting the node they want to track, then they can select the date in which they want to locate the Diginode. If the user clicks the green bullseye button, the map will fly to the correct date and location locating the Diginode. The date selector will only show dates that the selected Diginode has send GPS data for. Otherwise, there is no Diginode to locate and these DigiNodes will not display in the select Diginode drop down.

### Alerts:

The alerts feature keeps track of the incoming Diginode data showing the which Diginode, time and sensor value is above or below a user defined threshold value. As the Diginode push data to the server the alerts system will display the alerts onto the view highlighting in red which alerts the user has not clicked yet. If the user clicks on the alert, the map will fly to the time and place that the Diginode in question fell above or below its thresholds. These thresholds can be selected when clicking the set notification button. Here the user can specify when a specific Diginode value is considered above or below its threshold. If left blank, the alerts will ignore that senor value and not push an alert. The user can also choose to set the recommend thresholds which will default to a recommend threshold values set by Advent personnel.

These alerts currently only display in the web-portal but plans to allow these alerts to be wend directly to the user's mobile phone or email is currently in the works.

### Agro-Informatics:

### Updates:

An update to the Agro-informatics page gives the ability to select the 4 indexes and can view them on the map. This provides satellite data from Agromonitoring website directly onto the user's portal. The most recent average values are shown in the green buttons above and the button highlighted white is the currently selected view that the map is tied to showing the satellite map data.

### System Architecture:

Shown in FIG. 102 is a flow chart illustrating the system architecture. This details the service running on both the serve and gateway side and how the data is handled passing from the gateway to the server.

### Server Side:

The server is responsible for hosting the Fieldrich website and performing background tasks that help provide the features seen in the Fieldrich website. These background tasks are split into 4 services that are unique to each user account:
Alert Service
Database Bridge Service
Kriging (Surface Plot) Service
MQTT Bridge Service

### Alert Service:

The alert service is what provides the alert features shown in the Diginode page. This service is responsible for monitoring the Diginode data coming into the user's Diginode database. This service will compare each data point against the threshold values set by the user and will store the results in a MySQL database called alerts. Inside this database are tables that allow the website to keep track of each alert, which alert has been checked, and what to display on the website. For example, a table could tell the website to say that the water moisture and ambient temperature are above their threshold setting. All this information is stored in the alert database, and the monitoring is always running in the background separate from the website itself.

### Database Bridge Service:

The Database Bridge Service is responsible for bridging the data stored in a Postgres database setup by Chirpstack and will unsterilized the data and store in into the user's database. The Chirpstack system will store information and data from all the DigiNodes connected to the system including DigiNodes from all user accounts. The main purpose of the Database bridge is to filter the Diginode data by application (specific to each user account) and store their data into their database. This service also has some features embedded such as removing duplicates and can even rebuild a database if the user's database becomes corrupted. Each database is continuously being backup on a Synology driver every hour for an extra level of safety.

### Kriging (Surface Plot) Service:

This service is responsible for generating surface plot maps for the data visualization window in the Diginode page. This works by constantly checking the data being captured into the user's database and will generate a heatmap style image corresponding to a color code for each of the 7 sensors and stores them on the server in a folder named after the user's account. This will store the day, week and monthly images where the website and easily retrieve the image and information needed to display the Diginode data and location on the image.

### MQTT Bridge Service:

This service is responsible for communicating to the cloud-based MQTT server and will forward the Diginode data into the local MQTT broker server that Chirpstack is connected to. This works by connecting to the same topic that each gateway is publishing on from the gateway side and for every Diginode data or gateway stat that comes through, this service will relay that data directly into the Chirpstack server.

### Gateway Side:

Similar to the server side, the gateway also has services running in the background that help provide information directly to the user, operate other hardware components or help the system function as intended. There are 4 services that operate including:
Fan Service
MQTT Filter Service
LoRaWAN Service
Local Storage Service

### Fan Service:

The fan service is responsible for operating the gateway's fan and monitoring the gateway physical status. The hardware components are all controlled by a microcontroller attached to the gateway's main computer through USB. The gateway will monitor the ambient temperature and decide at what speed to set the fan. The microcontroller also monitors the battery and can provide the gateway with a battery voltage. These parameters are continuously updated onto the gateway portal for the user's convenience but will control the fan automatically keeping the system cool during hot days.

### MQTT Filter Service:

This service is responsible for filtering the data transmitted from the Diginode and only sending the important data to the cloud-based MQTT broker for the server to retrieve. This helps keep the data transmitted low, keeping the internet traffic to a minimal. It also will monitor the connection to the MQTT broker and will store the data locally to a MySQL database if either the internet connection or connection to the cloud based MQTT broker is unreachable. This helps to preserve the data during internet interruptions. This service will automatically upload the data when the system goes back online.

### LoRaWAN Service:

This service is responsible for operating the LoRaWAN receiver connected to the gateway. This service will collect the Diginode data and publish the data onto a local MQTT broker for the MQTT filter service to take over. It collects data such as gateway GPS data, Diginode data, gateway stats and other metadata. The parameters that drive this service can be controlled in the gateway portal and are important to the success of the entire data collection operation.

### Local Storage Service:

This service is responsible for monitoring the local database storage that the MQTT filters stores to prevent the database from growing too large. It also connects to the cloud based MQTT broker and will push the data that did not get sent due to internet interruptions.

### Data Pipeline:

Shown in FIG. 103 is how the data travels from the Diginode to the user's portal. Detailing all the steps and processes that occur.

The data starts by first being read by the DigiNode's sensors and is then serialized in the format shown in FIG. 103. Then the data is encoded using AppSEncryption, keys are stored directly within each Diginode and are used to encrypt the data prevent any form of interception adding an extra layer of security. Next the data is transmitted from the DigiNodes LoRaWAN transmitter and is picked up by the gateway's LoRaWAN Receiver. The gateway will then pass the data into the local MQTT broker where any unnecessary data is trimmed, including some metadata that is necessary to the overall functionality. Then the filtered data is either stored directly to the gateway or directly sent to the cloud-based MQTT broker. From here the data is then picked up by the server which is also connected to the same topic that the data was published on the cloud-based MQTT broker. Then the data is passed to the server's local MQTT broker that is connected to the Chirpstack server. Chirpstack will then decode the encrypted data and store the data in a Postgres database which is then picked up from the clients database bridge service that will un-serialize the data and store it into the clients MySQL database. Finally, when the user logs into their account on the Fieldrich website, the website will load the user's data stored inside their database and will calculate any values into their respected value. For example, the temperature data is stored as Celsius, the website is responsible for converting to Fahrenheit.

1. A system for sensing farm conditions comprising:
at least one sensor node configured to gather information about at least one farm;
at least one website; and
at least one communication protocol service for establishing communication between the at least one sensor node and the at least one website.

2. The system for sensing farm conditions of claim 1 further comprising wherein the at least one sensor node collects real time data about at least one farm condition.

3. The system for sensing farm conditions of claim 2 further comprising wherein the at least one farm condition is selected from ambient temperature, soil temperature, ambient pressure, ambient humidity, soil electrical conductivity, soil moisture, GPS data, ambient light conditions, at least one wind condition or combinations of the above.

4. The system for sensing farm conditions of claim 1 further comprising wherein the system is configured to provide access to the information gathered by the at least one sensor node via any device that can access the internet.

5. The system for sensing farm conditions of claim 1 further comprising wherein the at least one sensor note is configured to be waterproof.

6. The system for sensing farm conditions of claim 1 further comprising wherein the at least one website is an account-based website configured to allow access in real time to the information gathered by the at least one sensor node over a course of time the at least one sensor node is active.

7. The system for sensing farm conditions of claim 1 further comprising an artificial intelligence software module configured to provide information on improving field health and crop production.

8. The system for sensing farm conditions of claim 1 further comprising providing at least one agro-informatic data.

9. The system for sensing farm conditions of claim 8 further comprising wherein the at least one agro-informatic data comprises a normalized difference vegetation index (NDVI), an enhanced vegetation index (EVI), a disease stress water index (DSWI), a normalized difference water index (NDWI) and/or combinations of the above.

10. The system for sensing farm conditions of claim 1 further comprising at least one capacitive soil moisture sensor circuit.

11. A farm sensor node comprising:
at least one antennae;
at least one solar leaf configured to provide power to the farm sensor node;
at least one microcontroller configured to control the farm sensor node;
at least one real time clock configured for keeping time per a time zone containing at least one farm;
at least one multiplexer configured to control a dataflow from and to at least one farm sensor via serial communication;
at least one thermocouple temperature sensor; and
at least one environmental sensor configured to collect real time data about at least one farm condition.

12. The farm sensor node of claim 11 further comprising wherein the at least one farm condition is selected from ambient temperature, soil temperature, ambient pressure, ambient humidity, soil electrical conductivity, soil moisture, GPS data, at least ambient light condition, or at least one wind condition or combinations of the above.

13. The farm sensor node of claim 11 further comprising at least one TDS module configured to collect electrical conductivity data.

14. The farm sensor node of claim 11 further comprising wherein the at least one sensor note is configured as waterproof.

15. The farm sensor node of claim 11 wherein the farm sensor node is configured to communicate with at least one website configured to allow access in real time to the real time data gathered by the at least one sensor node over a course of time the at least one sensor node is active.

16. The farm sensor node of claim 11 wherein the farm sensor node is configured to communicate with an artificial intelligence software module configured to provide information on improving field health and crop production.

17. The farm sensor node of claim 11 wherein the farm sensor node is configured to collect at least one agro-informatic data.

18. The farm sensor node of claim 17 further comprising wherein the at least one agro-informatic data comprises a normalized difference vegetation index (NDVI), an enhanced vegetation index (EVI), a disease stress water index (DSWI), a normalized difference water index (NDWI) and/or combinations of the above.
